(19) United States
(12) Patent Application Publication
(10) Pub. No.: US 2014/0324632 A1
(43) Pub. Date: Oct. 30, 2014

(54) Product Search System, Product Search Server, Product Search Terminal, Product Search Method, and Storage Medium

(71) Applicants: Nobuyuki Enomoto, Tokyo (JP); Kazuya Furukawa, Tokyo (JP); Shigenobu Ito, Tokyo (JP); Masao Izumoto, Tokyo (JP); Kenji Shioume, Tokyo (JP)

(72) Inventors: Nobuyuki Enomoto, Tokyo (JP); Kazuya Furukawa, Tokyo (JP); Shigenobu Ito, Tokyo (JP); Masao Izumoto, Tokyo (JP); Kenji Shioume, Tokyo (JP)

(73) Assignee: NEC BIGLOBE, LTD., Tokyo (JP)

(21) Appl. No.: 14/346,851

(22) PCT Filed: Sep. 15, 2012
(86) PCT No.: PCT/JP2012/073750

§ 371 Date: Jun. 16, 2014

(30) Foreign Application Priority Data
Sep. 26, 2011 (JP) 2011-208868

(51) Int. Cl. G06Q 30/06

(52) U.S. Cl. CPC G06Q 30/0625
USPC 705/26.62

(57) ABSTRACT

This product search server is provided with: a WEB server which communicates with an exhibition terminal and a product search terminal; a control unit which performs processes in response to a request such as product offering, search, order, etc.; a clock which holds and returns the current time; an product-offering DB which accumulates offered-product information, registration time, latitudes and longitudes of registration places, and contact information of registrants; and a mail server which transmits order notification. With this structure, the offered product of the entry is displayed only when the distance (unit: kilometer [km]) from the entry registration place to the search place is less than the square value of the elapsed time (unit: hour [H]) from the entry registration to the search, so that the searcher located at a shorter distance from the seller can acquire the right of order earlier.

### TECHNICAL FIELD

The present invention relates to a product search system, and more particularly relates to display method of a search result in a service of transferring or selling items using a network.

### BACKGROUND ART

In recent years, there is a service that an exhibitor exhibits unnecessary items to a server on a network, and transfers them through the network. (see Patent Document 1)

Further, in the prior art, one proposes a technique to sort sales items on a display, according to a relation of latitude and longitude of a purchase requesting location and an item existing location. (see Patent Document 2)

Moreover, in the prior art regarding to product sales services a network, one proposes a technique with which a system displays products in the order in which a total payment of customers becomes lower with the consideration of product prices and postage. (see Patent Document 3)

In addition, relating to these prior arts, one proposes a technique with which people can buy an item from the supplier, who offers minimum cost, with the consideration of transportation costs and a map (see Patent Document 4) and a technique with which a system displays dealers in the order in which a transportation cost is cheaper. (see Patent Document 5)

However, when “limited item” (limited number item, limited sales period item, limited shop item, regionally limited item, other rare item, etc.) is transferred or sold, there existed a problem that one ca not reduce “transportation time, a transportation cost or an amount of carbon dioxide emission” by using a technique that “the closer the distance is, the upper it is displayed in a search result”.

For example, in the case of transferring or selling general items or products which are not limited, with display techniques shown in Patent Documents 3-5, it is possible to reduce transportation time, a transportation cost or an amount of carbon dioxide emission. However, in the case of transferring or selling amount-limited item such as an item for only-first-person, there exists a possibility that a customer located at a shorter distance from an exhibitor ca not buy the item because another customer located at a longer distance from the exhibitor made purchase order on ahead.

Therefore, in the case of transferring or selling a limited item, there existed a problem that one ca not minimize “transportation time, a transportation cost, or an amount of carbon dioxide emission” by using a technique that “the closer the distance is, the upper it is displayed in a search result” shown in Patent Documents 3-5.

### CITATION LIST

Patent Literature 1: JP2005-182584A

Patent Literature 2: JP2003-050859A

Patent Literature 3: JP2003-006079A

Patent Literature 4: JP2008-225622A

Patent Literature 5: JP2009-181542A

### SUMMARY OF THE INVENTION

The purpose of the present invention is to provide an item search system, an item search server, an item search terminal, an item search method, and a storage medium for reducing transportation time, a transportation cost, or an amount of carbon dioxide emission, in the case of offering (transferring, selling, etc.) limited items.

An item search system according to the present invention includes an item search server, an item exhibition terminal and an item search terminal. The item search server includes: a WEB server for offering limited items; a processing section for performing processes in response to a request such as an exhibition request, a search request, and an order request to the WEB server; a current time holding section for holding the current time; a searcher location receiving section for receiving location information of searchers; and an exhibition information storage section for storing item information, registration time and registration locations of exhibited items. The item exhibition terminal includes: a location acquisition section for measuring the latitude and longitude of the terminal location; and a browser for displaying a screen sent from the WEB server and transferring to the WEB server inputted contents by an exhibitor and the latitude and longitude of the terminal location as an exhibition request. The item search terminal includes: a location acquisition section for measuring the latitude and longitude of the terminal location; and a browser for displaying a screen sent from the WEB server and transferring to the WEB server inputted contents by a searcher and the latitude and longitude of the terminal location as a search request. The processing section calculates allowable elapsed time based on an item registration location and a searcher location and searches items which meet the condition that the current time has exceeded the allowable elapsed time from item registration time.

An item search server according to the present invention includes: a WEB server for offering limited items; a processing section for performing processes in response to a request such as an exhibition request, a search request and an order request to the WEB server; a current time holding section for holding the current time; a searcher location receiving section for receiving location information of searchers; and an exhibition information storage section for storing item information, registration time, and registration locations of exhibited items. The processing section calculates allowable elapsed time based on an item registration location and a searcher location and searches items which meet the condition that the current time has exceeded the allowable elapsed time from item registration time.

An item search terminal according to the present invention includes: a browser for inquiring item information, registration time, and registration locations of exhibited items in order to perform searches for limited items and performing a search process; a current time holding section for holding the current time; and a location acquisition section for acquiring a searcher location. The browser displays items which meet the condition that the current time has exceeded allowable elapsed time, which is calculated based on an item registration location and the searcher location, from item registration time.

An item search method according to the present invention includes: offering limited items by using a WEB server; performing processes in response to a request such as an exhibition request, a search request, and an order request to the WEB server; holding the current time; acquiring location information of searchers; storing item information, registration time and registration locations of exhibited items; calculating allowable elapsed time based on an item registration location and the searcher location; and searching items which meet the condition that the current time has exceeded said elapsed time from item registration time.

A program according to the present invention is the program to let a computer perform steps including: a step for offering limited items by using a WEB server; a step for performing processes in response to a request such as an exhibition request, a search request, and an order request to the WEB server; a step for holding the current time; a step for acquiring location information of searchers; a step for storing item information, registration time, and registration locations of exhibited items; a step for calculating allowable elapsed time based on an item registration location and searcher location; and a step for searching items which meet the condition that the current time has exceeded said elapsed time from item registration time. The program according to the present invention may be stored in a storage device or storage medium.

Thus, in the case of offering (transferring, selling, etc.) limited items, it is possible to reduce transportation time, a transportation cost, or an amount of carbon dioxide emission.

### BRIEF DESCRIPTION OF THE DRAWINGS

FIG. 1 is a schematic block diagram showing system configuration according to a first exemplary embodiment of the present invention.

FIG. 2 is a table showing contents of an exhibit item database 13 according to the first exemplary embodiment of the present invention.

FIG. 3 is a diagram showing an item registration screen 211 according to the first exemplary embodiment of the present invention.

FIG. 4 is a diagram showing a search execution screen 411 according to the first exemplary embodiment of the present invention.

FIG. 5 is a diagram showing a search result screen 412 according to the first exemplary embodiment of the present invention.

FIG. 6 is a diagram showing an order execution screen 413 according to the first exemplary embodiment of the present invention.

FIG. 7 is a diagram showing an order notification screen 231 according to the first exemplary embodiment of the present invention.

FIG. 8 is a flow chart showing operation of an exhibition process 121 according to the first exemplary embodiment of the present invention.

FIG. 9 is a flow chart showing operation of a search process 122 according to the first exemplary embodiment of the present invention.

FIG. 10 is a flow chart showing operation of an order process 123 according to the first exemplary embodiment of the present invention.

FIG. 11 is a diagram showing a relationship of locations among terminals and the relationship of time including item registration time and time when a search becomes possible according to the first exemplary embodiment of the present invention.

FIG. 12 is a diagram showing a relationship among item registration time, exhibited items, item exhibition terminals, search execution time, and search results according to the first exemplary embodiment of the present invention.

FIG. 13A is a diagram showing a search result (result A) in the case that one executed a search at 9:00 of Jul. 16, 2011 by using the first item search terminal 4 according to the first exemplary embodiment of the present invention.

FIG. 13B is a diagram showing a search result (result A) in the case that one executed a search at 9:00 of Jul. 16, 2011 by using the second item search terminal 5 according to the first exemplary embodiment of the present invention.

FIG. 14A is a diagram showing a search result (result B) in the case that one executed a search at 13:00 of Jul. 17, 2011 by using the first item search terminal 4 according to the first exemplary embodiment of the present invention.

FIG. 14B is a diagram showing a search result (result B) in the case that one executed a search at 13:00 of Jul. 17, 2011 by using the second item search terminal 5 according to the first exemplary embodiment of the present invention.

FIG. 15 is a schematic block diagram showing system configuration according to a second exemplary embodiment of the present invention.

FIG. 16 is a schematic block diagram showing system configuration according to the third exemplary embodiment of the present invention.

FIG. 17 is a table showing contents of an exhibit item database 13A according to a third exemplary embodiment of the present invention.

FIG. 18 is a diagram showing an item registration screen 211A according to the third exemplary embodiment of the present invention.

FIG. 19A is a table showing an example of a transportation cost table (Kanto departure) stored in a transportation cost calculation section 16 according to the third exemplary embodiment of the present invention.

FIG. 19B is a table showing an example of a transportation cost table (Kyushu departure) stored in a transportation cost calculation section 16 according to the third exemplary embodiment of the present invention.

FIG. 20 is a flow chart showing operation of a search process 122A according to the third exemplary embodiment of the present invention.

FIG. 21 is a flow chart showing operation of a search process 122B according to a fourth exemplary embodiment of the present invention.

FIG. 22 is a flow chart showing operation of a search process 122C according to a fifth exemplary embodiment of the present invention.

### DESCRIPTION OF THE EXEMPLARY EMBODIMENTS

### First Exemplary Embodiment

Referring to figures, the first exemplary embodiment of the present invention will be described below.

### (System Configuration)

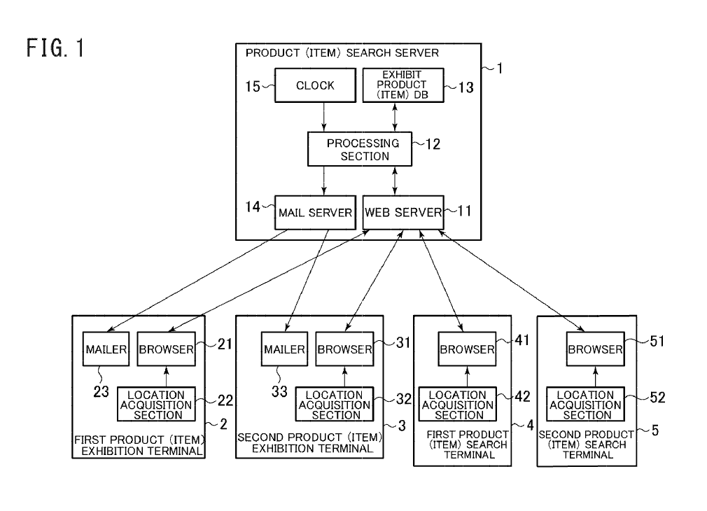

Referring to FIG. 1, configuration of an item search system according to the first exemplary embodiment of the present invention will be described below.

The item search system of the present exemplary embodiment includes an item search server, an item exhibition terminal, and an item search terminal. Here, it is supposed that the system includes at least one item exhibition terminal and one item search terminal.

In the example, the item search system of the present exemplary embodiment includes an item search server 1, a first item exhibition terminal 2, a second item exhibition terminal 3, a first item search terminal 4 and a second item search terminal 5.

The item search server 1 is a server device that is installed in an internet service provider to perform mediation services of item transfer and product sales between exhibitors and searchers (orderers). The item search server 1 executes processes in response to a request such as an exhibition request, a search request, and an order request from one terminal among the first item exhibition terminal 2, the second item exhibition terminal 3, the first item search terminal 4 and the second item search terminal 5. Then, the server 1 returns the result by a WEB screen or e-mail etc. to the terminal that had made the request.

The first item exhibition terminal 2 and the second item exhibition terminal 3 are terminals which an exhibitor uses, wherein the exhibitor is a person who wants to transfer an unnecessary item, a used item, a non-used item, a non-sales item, a distribution item, etc. or who wants to sell a product (a product of object of commerce). Here, an item or a product is not limited tangible one and may be intangible one. For example, an item or a product may be digital data, a program, etc. downloadable via a telecommunication line or may be a right (a ticket etc.) to receive some services. Moreover, in fact, it is not limited to transfer and sale, and it may be lease or the like. The first item exhibition terminal 2 and the second item exhibition terminal 3 request an exhibition process (entry registration) to the item search server 1. Then, if a purchaser for exhibited item appears, the item exhibition terminal receives an order notification by e-mail from the item search server 1. The first item exhibition terminal 2 and the second item exhibition terminal 3, basically, have the same configuration, and execute the same operation.

The first item search terminal 4 and the second item search terminal 5 are terminals which a searcher uses, wherein the searcher is a person who wants to get an exhibited item or buys a product. The first item search terminal 4 and the second item search terminal 5 request a search process and an order process to the item search server through a WEB screen.

### (Details of the Configuration)

Detail configuration of the item search server 1, the first item exhibition terminal 2, the second item exhibition terminal 3, the first item search terminal 4, and the second item search terminal 5 will be described below.

The item search server 1 includes a WEB server 11, a processing section 12, an exhibit item DB (database) 13, a mail server 14 and a clock 15.

The WEB server 11 receives a request from one of the browsers among the first item exhibition terminal 2, the second item exhibition terminal 3, the first item search terminal 4, and the second item search terminal 5 and transfers said request to the processing section 12. In addition, the WEB server 11 returns the process result received from the processing section 12 to the terminal browser which is the source of the request. Here, the WEB server 11 may be a device for executing server software. Further, the WEB server 11 may be an external server connected to the item search server 1.

The processing section 12 receives the request from the WEB server 11, executes one of the processes among an exhibition process 121, a search process 122, and an order process 123 and returns the result to the WEB server 11. At this time, the processing section 12 refers to the exhibit item DB 13 and the clock 15 if necessary. Here, under the control of software, the processing section 12 performs the exhibition process 121, the search process 122, or the order process 123. However, in practice, the processing section 12 may have the function blocks for executing the exhibition process 121, the search process 122, and the order process 123. Furthermore, the processing section 12 sends e-mail through the mail server 14 if necessary. In addition, the processing section 12 also has a register to manage exhibition IDs.

The exhibit item DB 13 is a database for registering exhibited items or products from exhibitors in response to requests from the first item exhibition terminal 2 and the second item exhibition terminal 3. The DB 13 records an exhibition ID, an item name, item description, registration time, latitude of registration location, longitude of registration location, and the registrant contact for each entry. The DB 13 is searchable in the condition combining a plurality of search items, arbitrarily.

The mail server 14 has both SMTP (Simple Mail Transfer Protocol) server function for sending e-mail to an indicated address and POP (Post Office Protocol) server function/IMAP4 server function for storing e-mail that has been sent and dealing with a receive request from a destination user. Of course, in practice, it is not limited to SMTP, POP/IMAP4. It is possible to use techniques which correspond to them, or techniques which will be developed/extended in future. Here, in case of using WEB mail, the WEB server 11 also serves as the mail server 14. In other words, the WEB server 11 also plays a role of the mail server 14.

Further, the mail server 14 has the following functions:

(1) Function for transferring e-mail to a mail server of a designated destination in response to a request from the processing section 12,
(2) Function for storing e-mail addressed to accounts which are managed by itself (mail server 14), and
(3) Function for transferring stored e-mail in response to a mail read request from a mailer in the first item exhibition terminal 2 or a mailer in the second item exhibition terminal 3.

The clock 15 returns the current date and time (year, month, day, hour, minute, and second) in response to a request from the processing section 12. The clock 15 always acquires and retains the exact date and time by using NTP (Network Time Protocol), GPS (Global Positioning System), or the like. For example, the clock 15 acquires and retains UTC (Coordinated Universal Time), GMT (Greenwich Mean Time), or the like. Alternatively, the clock 15 may measure the exact time by itself by using an atomic clock, etc.

The first item exhibition terminal 2 includes a browser 21, a location acquisition section 22, and a mailer 23.

The second item exhibition terminal 3 includes a browser 31, a location acquisition section 32, and a mailer 33.

The first item search terminal 4 includes a browser 41 and a location acquisition section 42.

The second item search terminal 5 includes a browser 51 and a location acquisition section 52.

In response to an exhibitor instruction, the browser 21, 31, 41, 51 performs a WEB page browsing request to the WEB server and displays acquired WEB page for the exhibitor. In performing the WEB browsing request, data inputted by an exhibitor, and the latitude and longitude which are obtained from the location acquisition section 22, 32, 42, 52 may be sent to the WEB server. In addition, the browser 21, 31, 41, 51 may be a device for executing application software of the WEB browser or the like. Here, the browser 21, 31, 41, 51 includes hardware that is used to implement a browser. For example, the browser 21, 31, 41, 51 includes a storage device for storing application software such as a WEB browser, a processing unit to execute the application software, and a display device for displaying the WEB browser.

The location acquisition section 22, 32, 42, 52 identifies the location of said terminal (latitude and longitude of the terminal location) by using GPS (Global Positioning System), cellular phone base station positioning, or wireless LAN base station (access point) positioning (WLAN positioning) alone or in combination of them. Then, the location acquisition section 22, 32, 42, 52 returns the latitude and longitude to the browser 21, 31, 41, 51.

The mailer 23, 33 executes a mail read request to the mail server 14 by using POP protocol, etc., displays e-mail read for the exhibitor, and stores said e-mail. Here, the mailer 23 and 33 includes hardware that is used to implement a mailer. For example, the mailer 23, 33 includes a storage device for storing application software such as a mailer, a processing unit to execute said application software, and a display device for displaying the mailer. In addition, in the case of using the WEB mail, the browser 21, 31 also serves as the mailer 23, 33. In other words, the browser 21, 31 plays a role of the mailer 23, 33.

### (Illustration of Hardware)

An example of the specific hardware for implementing an item search system according to the present invention will be described below.

Example of an item search server 1 is a PC (personal computer), an appliance, a workstation, a mainframe, a supercomputer, or the like.

Example of the first item exhibition terminal 2, the second item exhibition terminal 3, the first item search terminal 4, or the second item search terminal 5 is a mobile phone with GPS, a smart phone, a smart book, a PC (personal computer), a mobile notebook PC, a car navigation system, a portable game machine, a home-use game machine, a portable music player, a handy terminal, a gadget (electronic appliance), an interactive television, a digital tuner, a digital recorder, an information home appliance, an OA (Office Automation) appliance, a point of sale terminal, a high-function copier, a digital signage, or the like. In addition, the first item exhibition terminal 2, the second item exhibition terminal 3, the first item search terminal 4, and the second item search terminal 5 may be installed in a moving body such as a vehicle, a ship, and an aircraft.

Further, the item search server 1, the first item exhibition terminal 2, the second item exhibition terminal 3, the first item search terminal 4, and the second item search terminal 5 are not limited to terminals or servers. They may be relay equipment or peripheral equipment. Alternatively, the item search server 1, the first item exhibition terminal 2, the second item exhibition terminal 3, the first item search terminal 4, and the second item search terminal 5 may be an expansion board to be mounted on a computer, etc., a virtual machine that is built on a physical machine (VM: Virtual Machine).

Although not shown in figures, each of the item search server 1, the first item exhibition terminal 2, the second item exhibition terminal 3, the first item search terminal 4, and the second item search terminal 5 is realized with a processor driven based on a program for executing predetermined processing, a memory for storing said program and various data, and an interface used for communication with the network.

Example of the processor is a CPU (Central Processing Unit), a network processor (NP: Network Processor), a microprocessor, a microcontroller, or a semiconductor integrated circuit (LSI: Large Scale Integration) having a special function, etc.

Example of the memory is a semiconductor memory device such as a RAM (Random Access Memory), a ROM (Read Only Memory), an EEPROM (Electrically Erasable and Programmable Read Only Memory), and a flash memory, an auxiliary storage device such as a HDD (Hard Disk Drive) and a SSD (Solid State Drive), or a storage medium such as removable disk, for example a DVD (Digital Versatile Disk), and a SD memory card (Secure Digital memory card), or the like. Alternatively, the memory may be a buffer or a register. Further alternatively, the memory may be a storage device using DAS (Direct Attached Storage), FC-SAN (Fibre Channel-Storage Area Network), NAS (Network Attached Storage), IP-SAN (IP-Storage Area Network), or the like.

In addition, said processor and said memory may be integrated. For example, in recent years, single chip, such as a single chip microcomputer, is progressing. Thus, we can consider an example that a single chip microcomputer mounted on an electronic appliance or the like includes said processor and said memory.

Example of the interface is a board (motherboard, I/O board) adapted to network communication, a semiconductor integrated circuit such as the chip, a network adapter such as NIC (Network Interface Card), an expansion card of the same, a communication device such as an antenna, a communication port such as a connector, or the like.

Further, example of a network is an internet, a LAN (Local Area Network), a Wireless LAN, a WAN (Wide Area Network), a Backbone, a cable television (CATV) line, a fixed telephone network, a mobile phone network, WiMAX (IEEE 802.16a), 3G (3rd Generation), a lease line, IrDA (Infrared Data Association), Bluetooth (registered trademark), serial communication line, data bus, or the like.

In addition, component within each of the item search server 1, the first item exhibition terminal 2, the second item exhibition terminal 3, the first item search terminal 4, and the second item search terminal 5 may be a module, a component, a special device, or a start-up (calling) program for them.

However, in practice, it is not limited to these examples.

### (Configuration of an Exhibit Item DB)

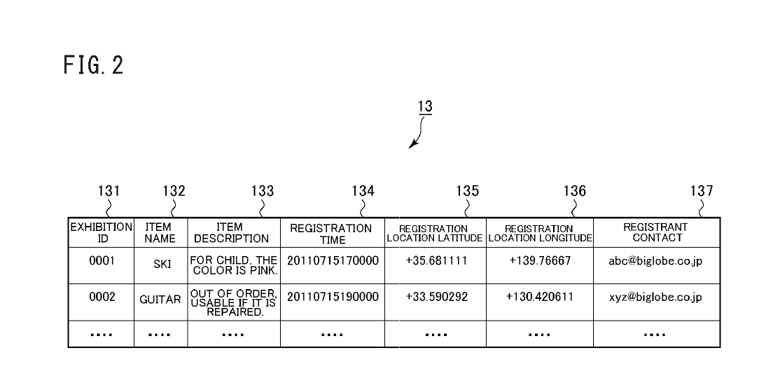

Referring to FIG. 2, configuration example of an exhibit item DB 13 will be described below.

The exhibit item DB 13 includes exhibition ID 131, item name 132, item description 133, registration time 134, registration location latitude 135, registration location longitude 136, and registrant contact 137.

Exhibition ID 131 is a field (memory area) for recording a number with which an exhibited item or product is uniquely identified. Exhibition ID is not a number that identifies an exhibitor or a type or model of item or product. So, in case, for example, that the same exhibitor exhibits the same model item more than once, the processing section 12 gives different exhibition ID for each exhibited item and registers it in the field of exhibition ID 131. In other words, exhibition ID should not be overlapped.

Item name 132 is a field for recording a name of an exhibited item or product. For example, the processing section 12 registers rough genre of item or product (classification of item or product etc.) such as ski, guitar and personal computer in the field of item name 132 by character, code, or the like.

Item description 133 is a field for recording a description of an exhibit item or product. For example, the processing section 12 registers information such as size, color, manufacturer, model number, product image URL, item code and condition of item (scratch/failure/new/unopened etc.) in the field of item description 133.

Registration time 134 is a field for recording the date and time (year, month, day, hour, minute, and second) in which an exhibition process 121 was executed.

Registration location latitude 135 is a field for recording latitude of a location where the exhibition process 121 was executed. The latitude is described in decimal notation, and positive value and negative value represent north latitude and south latitude, respectively.

Registration location longitude 136 is a field for recording longitude of a location where the exhibition process 121 was executed. The longitude is described in decimal notation, and positive value and negative value represent east longitude and west longitude, respectively.

Registrant contact 137 is a field for recording e-mail address of an exhibitor who executed the exhibition process 121. If there is a request (order) to “want” the exhibited item or product, the processing section 12 sends e-mail of order notification to the e-mail address that is recorded in the field of registrant contact 137.

### (Configuration of an Item Registration Screen)

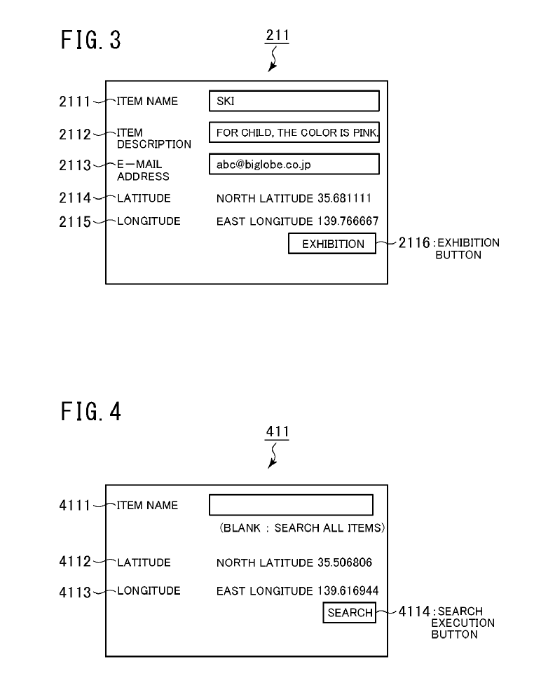

Referring to FIG. 3, a configuration example of an item registration screen 211 displayed in the browser 21 when the exhibitor executes the exhibition process 121 for an item or product will be described below.

The item registration screen 211 includes item name 2111, item description 2112, e-mail address 2113, latitude 2114, longitude 2115, and button 2116 for executing exhibition.

Item name 2111 is a field for setting (input, selection, etc.) a name of the exhibit item or product. For example, the browser 21 registers rough genre of the item or product (classification of item or product etc.) such as ski, guitar and personal computer in the field of item name 2111 by character, code, or the like.

Item description 2112 is a field for setting a description of the exhibit item or product. For example, the browser 21 registers information such as size, color, manufacturer, model number, product image URL, item code and condition of item (scratch/failure/new/unopened etc.) in the field of item description 2112.

E-mail address 2113 is a field for setting e-mail address of an exhibitor who executes the exhibition process 121. For example, the browser 21 sends order notification by e-mail etc. to the e-mail address that is set in the field of e-mail address 2113, if there is a request (order) to “want” the exhibited item or product.

Latitude 2114 is a field for displaying latitude which the browser 21 received from the location acquisition section 22 when displaying the item registration screen 211. The latitude is described in decimal notation, and positive value and negative value represent north latitude and south latitude, respectively.

Longitude 2115 is a field for displaying longitude which the browser 21 received from the location acquisition section 22 when displaying the item registration screen 211. The longitude is described in decimal notation, and positive value and negative value represent east longitude and west longitude, respectively.

An exhibition button 2116 is a button for sending to the WEB server 11 the information, which is set/displayed in the fields of item name 2111, item description 2112, e-mail address 2113, latitude 2114 and longitude 2115 in the item registration screen 211 by using POST method (or GET method) etc. of HTTP (HyperText Transfer Protocol), and for starting the exhibition process 121 of the browser 21. For example, in the case of the POST method, there is a body part same as the response message from the server, and the data to be sent is described in the body part. In the case of the GET method, “?” is attached at the end of a file name of URL etc., and “?” is followed by a description of data to be sent in the form of “parameter name=value”. It is also possible to send multiple parameters by separating parameters by “&”.

### (Configuration of a Search Execution Screen)

Referring to FIG. 4, a configuration example of a search execution screen 411 displayed in the browser 41 when a searcher executes search for an item or product will be described below.

The search execution screen 411 includes item name 4111, latitude 4112, longitude 4113, and button 4114 for executing search.

Item name 4111 is a field for setting a name of an item or product for search. For example, the browser 41 describes rough genre of item or product (classification of item or product etc.) such as ski, guitar and personal computer in the field of item name 4111 by character, code, or the like. The browser 41 executes search without narrowing down with the item name, when executing search by pressing the search execution button 4114 while left blank the field of item name 4111.

Latitude 4112 is a field for displaying latitude which the browser 41 received from a location acquisition section 42 when displaying the search execution screen 411. The latitude is described in decimal notation, and positive value and negative value represent north latitude and south latitude, respectively.

Longitude 4113 is a field for displaying longitude which the browser 41 received from the location acquisition section 42 when displaying the search execution screen 411. The longitude is described in decimal notation, and positive value and negative value represent east longitude and west longitude, respectively.

A search execution button 4114 is a button for sending to the WEB server 11 the information, which is set/displayed in the fields of item name 4111, latitude 4112 and longitude 4113 in the search execution screen 411 by using POST method etc. of HTTP, and for starting the search process 122 by the processing section 12.

### (Configuration of a Search Result Screen 412)

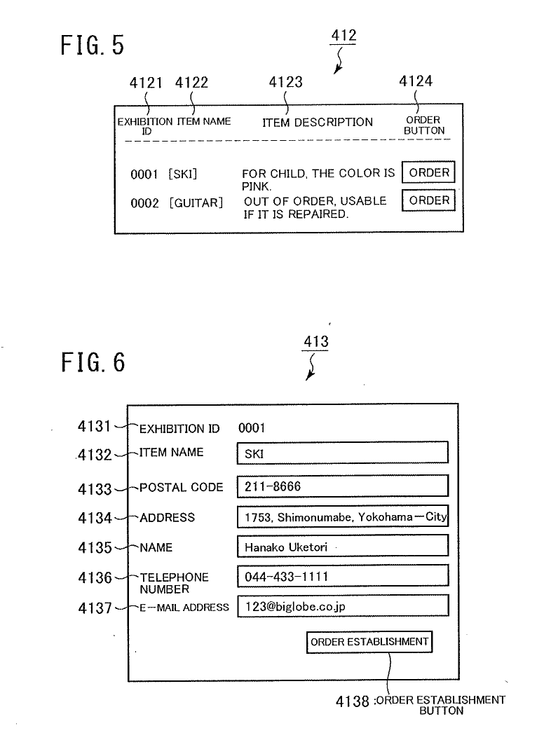

Referring to FIG. 5, a configuration example of a search result screen 412 displayed in the browser 41 as a result of having been executed the search process 122 by the processing section 12, after the searcher requested the search in the search execution screen 411 will be described below.

The search result screen 412 includes exhibition ID 4121, item name 4122, item description 4123, and order button 4124.

Exhibition ID 4121 is a field for displaying a number with which an exhibited item or product is uniquely identified.

Item name 4122 is a field for displaying a name of the exhibited item or product. For example, the browser 41 displays rough genre of item or product (classification of item or product etc.) such as ski, guitar and personal computer in the field of item name 4122.

Item description 4123 is a field for displaying a description of the exhibited item or product. For example, the browser 41 displays information such as size, color, manufacturer, model number, product image URL, item code, condition of item (scratch/failure/new/unopened etc.), and the like in the field of item description 4123.

An order button 4124 is a button for sending an exhibition ID corresponding to each button (entry) to the WEB server 11 by using POST method etc. of HTTP, and for acquiring an order execution screen 413.

### (Configuration of the Order Execution Screen 413)

Referring to FIG. 6, a configuration example of the order execution screen 413 sent from the WEB server and displayed in the browser 41, as a result of pushing down of the order execution button after the exhibitor checked the search result in the search result screen 412 will be described below.

The order execution screen 413 includes exhibition ID 4131, item name 4132, postal code 4133, address 4134, name 4135, telephone number 4136, e-mail address 4137, and order establishment button 4138.

Exhibition ID 4131 is a field for displaying a number with which an item or a product to be ordered is uniquely identified.

Item name 4132 is a field for displaying a name of the item or product to be ordered. For example, rough genre of item or product (classification of item or product etc.) such as ski, guitar and personal computer is displayed.

Postal code 4133 is a field for setting a destination postal code for the item or product to be ordered.

Address 4134 is a field for setting a destination address for the item or product to be ordered.

Name 4135 is a field for setting an addressee's name for the item or the product to order.

Telephone number 4136 is a field for setting a destination telephone number for the item or product to be ordered.

E-mail address 4137 is a field for setting e-mail address of the orderer.

An order establishment button 4138 is a button for sending information set/displayed in the fields of exhibition ID 4131, postal code 4133, address 4134, name 4135, telephone number 4136 and e-mail address 4137 in the order execution screen 413, and starting order process 123 by the processing section 12.

### (Configuration of Order Notification)

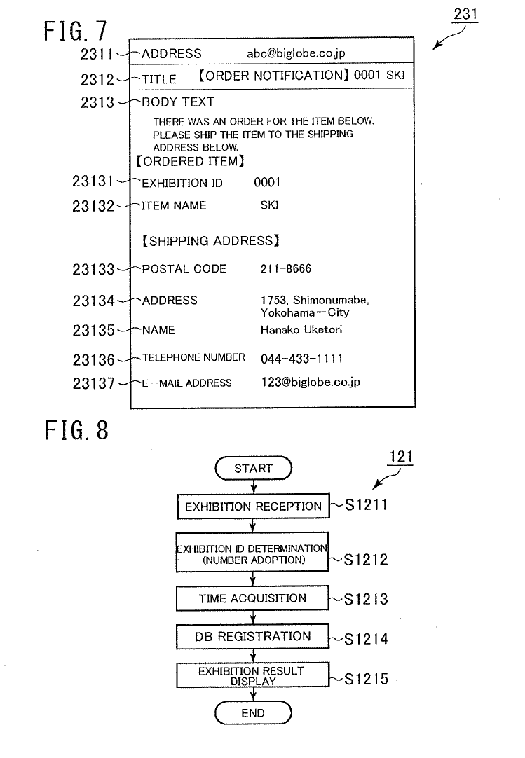

Referring to FIG. 7, a configuration example of order notification 231, which is e-mail sent to the mailer 23 or displayed in it of the first item exhibition terminal 2 through the mail server 14, as a result of execution of the order process 123 by the processing section 12 after the searcher pushed down the order establishment button, will be described below.

The order notification 231 includes address 2311, tittle 2312, and body text 2313.

Address 2311 is a field for displaying e-mail address which exhibitor set when he executed exhibition process 121 for the product etc. in the item registration screen 211.

Tittle 2312 is a field for displaying: character string labeled as “order notification”, which indicates that said e-mail is order notification; exhibition ID which was adopted number in executing exhibition process 121 for the product etc. in the item registration screen 211 by the exhibitor; and the product name set in the exhibition process 121.

Body text 2313 is a field for displaying text: which indicates that there was an order for the exhibited item or product and that shipment processing should be executed; the exhibition ID and the product name for identifying the ordered product; and postal code, address, name, telephone number and e-mail address for identifying shipping destination.

Here, body text 2313 includes exhibition ID 23131, product name 23132, postal code 23133, address 23134, telephone number 23136, and e-mail address 23137.

Exhibition ID 23131 is a field for displaying a number for uniquely identifying an ordered item or product.

Product name 23132 is a field for displaying the name of ordered item or product. For example, the processing section 12 makes display rough genre of item or product (classification of item or product etc.) such as ski, guitar and personal computer in the field of product name 23132.

Postal code 23133 is a field for displaying a destination postal code for the ordered item or product.

Address 23134 is a field for displaying a destination address for the ordered item or product.

Name 23135 is a field for displaying an addressee's name for ordered item or product.

Telephone number 23136 is a field for displaying an addressee's telephone number for ordered item or product.

E-mail address 23137 is a field for displaying e-mail address for the orderer.

In FIG. 7, although the source of order notification 231 is omitted, e-mail address of the orderer (for example, if orderer's e-mail address is “123@biglobe.co.jp”, “123@biglobe.co.jp” can be used.) can be used. Alternatively, e-mail address which the system possesses (for example, “system@biglobe.co.jp”) can always be used regardless of who is orderer.

### (Operation of an Exhibition Process)

Referring to FIG. 8, operation of an exhibition process 121 executed in the processing section 12 will be described below.

### (1) Step S1211

The processing section 12 starts up the exhibition process 121 when said processing section receives from the WEB server 11 the information which is set/displayed in the fields of item name 2111, item description 2112, e-mail address 2113, latitude 2114, and longitude 2115 in the item registration screen 211 by the exhibitor.

### (2) Step S1212

The processing section 12 possesses a register for managing exhibition IDs. Said section 12 adopts a numerical value, which is obtained by adding one (incrementing) with a number stored in the register, as an exhibition ID. Then, said section 12 stores said numerical value in the register. Here, the numerical value to increase is not limited to “1”. Actually, it is not a problem if a number stored in the register gradually increases without overlapping.

### (3) Step S1213

The processing section 12 acquires the current date and time (year, month, day, hour, minute, and second) from the clock 15.

### (4) Step S1214

The processing section 12 registers on the exhibit item DB 13 the exhibition ID adopted in Step S1212, the current date and time (year, month, day, hour, minute, and second) acquired in Step S1213, and item name, item description, e-mail address, latitude and longitude acquired in Step S1211.

### (5) Step S1215

The processing section 12 displays on the browser 21 through WEB server 11 an indication, which indicates that the exhibition process 121 was complete, and the exhibition ID which was adopted in Step S1212. Then, said section 12 ends processing.

### (Operation of a Search Process)

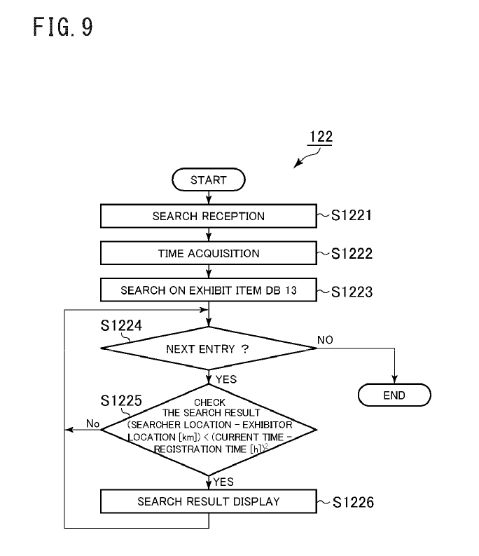

Referring to FIG. 9, operation of a search process 122 executed in the processing section 12 will be described below.

### (1) Step S1221

The processing section 12 starts up the search process 122 when said processing section 12 receives from the WEB server 11 the information which is set/displayed in the field of item name 4111, latitude 4112, and longitude 4113 in the search execution screen 411 by the searcher.

### (2) Step S1222

The processing section 12 acquires the current date and time (year, month, day, hour, minute, and second) from the clock 15.

### (3) Step S1223

The processing section 12 executes a search on the exhibit item DB 13 with keys which are the latitude and longitude acquired in Step S1221, and acquires a maximum of 200 entries in the order in which the distance from the spot with the latitude and longitude is closer. Here, if an item name was specified, namely a field of item name is not being left as a blank column in step S1221, search results are narrowed by using the item name. Each entry acquired, as a result of the executing search on the exhibit item DB 13, includes exhibition ID, item name, item description, registration time, latitude of registration location, longitude of registration location, and registrant contact.

### (4) Step S1224

The processing section 12 selects an entry (maximum of 200 entries) acquired in Step S1223 orderly one by one. If an entry which should be selected exists, it proceeds in Step S1225. If an entry which should be selected does not exist, it ends processing.

### (5) Step S1225

The processing section 12 evaluates the entry which was selected in Step S1224 “whether or not a distance (The unit: kilometer “km”) from an entry registration location (executing location of the exhibition process) to the search location (executing location of the search process) is less than the square value of elapsed time (The unit: hour “H”), which is from the entry registration (registration time) to the search (search execution time)”. If the evaluation is “YES”, it proceeds in Step S1226. If the evaluation is “NO”, it returns in Step S1224 and selects next entry. Here, the distance (The unit: kilometer “km”) from the entry registration location (executing location of the exhibition process) to the search location (executing location of the search process) is calculated by using the latitude and longitude at search time acquired in Step S1221 and the latitude and longitude at registration time of the entry acquired in Step S1223. Further, elapsed time (The unit: hour “H”) from the entry registration (registration time) to the search (search execution time) is calculated by using the difference, which is subtraction of the registration time of the entry acquired in Step S1223 from the current time acquired in Step S1222.

### (6) Step S1226

If the evaluation for the entry selected in Step S1225 is “YES”, the processing section 12 sends exhibition ID, item name, and item description of the entry to the WEB server 11. Then, said section 12 makes display the contents of entry in the search result screen 412. After that, it returns in Step S1224 and selects next entry.

### (Operation of an Order Process)

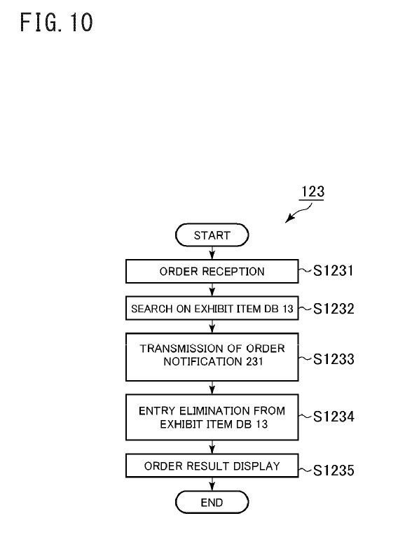

Referring to FIG. 10, operation of an order process 123 executed in the processing section 12 will be described below.

### (1) Step S1231

The processing section 12 starts up the order process 123 when said processing section receives from the WEB server 11 the information which is set/displayed in the field of exhibition ID 4131, postal code 4133, address 4134, name 4135, telephone number 4136, and e-mail address 4137 in the order execution screen 413.

### (2) Step S1232

The processing section 12 executes a search on the exhibit item DB 13 with a key which is an exhibition ID acquired in Step S1231, and acquires one entry which corresponds to the exhibition ID. This entry includes exhibition ID, item name, item description, registration time, latitude of registration location, longitude of registration location, and registrant contact.

### (3) Step S1233

The processing section 12 generates order notification 231, which is e-mail to notify that there was an order to the exhibitor, and sends it to the mailer 23 through the mail server 14. The processing section 12 sets following display contents in the fields of address 2311, title 2312, and body text 2313 when the order notification 231 is generated. In the field of the address 2311, it sets registrant contact acquired in Step S1232. In the field of the title 2312, it sets the text which represents “order notification”, and the exhibition ID and the item name acquired in Step S1232. In the field of the body text 2312, it sets the text which indicates that there was an order for the exhibited item or product and that shipment processing should be executed, the exhibition ID and the item name acquired in Step S1232, and postal code, address, name, telephone number and e-mail address, as shipping destination, acquired in Step S1231.

### (4) Step S1234

The processing section 12 executes a search on the exhibit item DB 13 with a key, which is exhibition ID acquired in Step S1231, and deletes one entry which corresponds to the exhibition ID. With this process, it prevents that more than one order is done to the item or product which corresponds to the exhibition ID. In other words, it makes possible that only one order can be done for one exhibition ID.

### (5) Step S1235

The processing section 12 makes the browser 41 through the WEB server 11 display an indication which indicates that the order process 123 was complete, the exhibition ID acquired in Step S1231 and the item name acquired in Step S1232. Then, said section 12 ends processing.

In the present exemplary embodiment, e-mail address of the exhibitor, who executed the exhibition process 121, is registered in the field of the registrant contact 137. However, it is possible to register a mobile phone number instead of e-mail address, and make notify by short message service (SMS). It is also possible to register an account of the social networking service (SNS), and notify that there was an order by using the message transfer function of SNS.

Further, in the present exemplary embodiment, in calculating the distance between the item exhibition terminal and the item search terminal, the latitude and longitude which were acquired by the terminal in the item exhibition process or in the item search process. However, instead of using latitude and longitude, it is possible to let an exhibitor or a searcher to input address, postal code, and area code of fix-line telephone etc. of a ship-from or a shipping destination in the item registration screen or the search execution screen. Thus, the distance between an exhibitor and a searcher can be calculated by using inputted information. Further, it is possible to add a member database and introduce a member system, and the distance between an exhibitor and a searcher is calculated by using registered addresses.

### (First Example of Operation: Operation of the Exhibition Process)

Hereinafter, referring to FIG. 1 to FIG. 3 and FIG. 8 and using the example case in which a ski is exhibited by using the first item exhibition terminal 2 which is located in Tokyo (“North latitude 35.681111”, “East longitude 139.766667”) at 17:00 on Jul. 15, 2011, operation of the exhibition process will be explained. Here, it is supposed that a register value for managing exhibition IDs in the processing section was set to “0000”.

An exhibitor, who wants an exhibition of a ski, accesses the WEB server 11 by using the browser 21 in the first item exhibition terminal 2 shown in FIG. 1, and acquires the item registration screen 211 shown in FIG. 3.

In displaying the item registration screen 211, the browser 21 acquires the latitude and longitude of the first item exhibition terminal 2 from the location acquisition section 22 and displays latitude 2114 and longitude 2115 in the item registration screen 211. Here, it is supposed that latitude 2114 is “North latitude 35.681111” and longitude 2115 is “East longitude 139.766667”.

Here, it is supposed that the exhibitor inputs “ski” in the field of item name 2111, “for child, the color is pink” in the field of item description and “abc@biglobe.co.jp” in the field of e-mail address 2113 as shown in FIG. 3, and that he pushes the exhibition button 2116 after inputting.

After the exhibition button 2116 is pushed, the contents which were inputted or set in the item registration screen 211 are transferred to the WEB server 11 by using the POST method of HTTP. Then, the WEB server 11 starts up exhibition process 121 shown in FIG. 8.

As the process of Step S1211 of the exhibition process 121, the processing section 12 receives from the WEB server 11 the information set/displayed in the field of item name 2111, item description 2112, e-mail address 2113, latitude 2114 and longitude 2115 in the item registration screen 211.

As the process of Step S1212 of the exhibition process 121, the processing section 12 refers to the register which manages exhibition ID and extracts a value of “0000”. Then, “0001”, which is obtained by adding one with the extracted value, is adopted as the exhibition ID of the exhibition process 121 of this time, and the register holds “0001”.

As the process of Step S1213 of the exhibition process 121, the processing section 12 obtains from the clock 15 the current date and time (year, month, day, hour, minute, and second). As a result, it acquires a value, “20110715170000”.

As the process of Step S1214 of the exhibition process 121, the processing section 12 registers on the exhibit item DB 13: exhibition ID which was adopted in Step S1212; the current date and time (year, month, day, hour, minute, and second) which was acquired in Step S1213; and item name, item description, e-mail address, latitude and longitude which was acquired in Step S1211.

As a result, the entry which corresponds to exhibition ID “0001” shown in FIG. 2 is registered on the exhibit item DB 13. Namely, in the field of exhibition ID 131, “0001” is set; in the field of item name 132, “ski” is set; in the field of item description 133, “for child, the color is pink” is set; in the field of registration time 134, “20110715170000” is set; in the field of latitude of registration location 135, “+35.681111” is set; in the field of longitude of registration location 136, “+139.766667” is set; and in the field of registrant contact 137, “abc@biglobe.co.jp” is set.

As the process of Step S1215 of the exhibition process 121, the processing section 12 makes display on the browser 21 through the WEB server 11 an indication which indicates that the exhibition process 121 was complete and the exhibition ID “0001” which was adopted in Step S1212.

The browser 21 displays the exhibition result sent from the WEB server 11. Then, a series of exhibition operation completes when the exhibitor confirms exhibition ID “0001”.

### (Second Example of Operation: Operation of the Search Process)

Hereinafter, referring to FIG. 1, FIG. 2, FIG. 4, FIG. 5 and FIG. 9 and using the example case which a ski is exhibited by using the first item exhibition terminal 2 which is located in Tokyo (“North latitude 35.681111”, “East longitude 139.766667”) at 17:00 on Jul. 15, 2011, a guitar is exhibited by using the second item exhibition terminal 3 which is located in Hakata (“North latitude 33.590292”, “East longitude 130.420611”) at 19:00 on Jul. 15, 2011, and the search is done without specifying an item name (leaving the column blank) by using the first item search terminal 4 located in Yokohama (“North latitude 35.506806”, “East longitude 139.616944”) at 13:00 on Jul. 17, 2011, operation of the search process will be explained. Here, it is supposed that an order has been done neither for the ski nor the guitar by the time of the display of the search result.

A searcher, who wants an item or a product, accesses the WEB server 11 by using the browser 41 in the first item search terminal 4 shown in FIG. 1, and acquires the search execution screen 411 shown in FIG. 4.

In displaying the search execution screen 411, the browser 41 acquires the latitude and longitude of the first item search terminal 4 from the location acquisition section 42 and displays latitude 4112 and longitude 4113 in the search execution screen 411. Here, it is supposed that latitude 4112 is “North latitude 35.506806” and longitude 4113 is “East longitude 139.616944”.

Here, it is supposed that the searcher pushes a search execution button 4114 with leaving the field of item name 4111 blank, as indicated in FIG. 4.

After the search execution button 4114 is pushed, the contents inputted or set in the search execution screen 411 are transferred to the WEB server 11 by using the POST method of HTTP. Then, the WEB server 11 starts up the search process 122 shown in FIG. 9.

As the process of Step S1221 of the search process 122, the processing section 12 receives from WEB server 11 the information set/displayed in the field of item name 4111, latitude 4112 and longitude 4113 in the search execution screen 411.

As the process of Step S1222 of the search process 122, the processing section 12 acquires the current date and time (year, month, day, hour, minute, and second) from the clock 15. As a result, the processing section 12 acquires a value, “20110717130000”.

As the process of Step S1223 of the search process 122, the processing section 12 executes a search on the exhibit item DB 13 with keys, which are the latitude and longitude (“North latitude 35.506806”, “East longitude 139.616944”) acquired in Step S1221, and acquires a maximum of 200 entries in the order in which the distance from the spot with the latitude and longitude is closer. Here, it is supposed that two entries whose exhibition IDs are “0001” and “0002” shown in FIG. 2 could be acquired. This time, because the field of the item name is a blank column, narrowing the search results by using the item name are not executed.

As the process of Step S1224 of the search process 122, the processing section 12 selects the entry (two entries) acquired in Step S1223 orderly one by one. At first, it selects the entry which corresponds to exhibition ID “0001”.

As the process of Step S1225 of the search process 122, the processing section 12 evaluates the entry (exhibition ID “0001”) which was selected in Step S1224 “whether or not a distance (The unit: kilometer “km”) from the entry registration location (executing location of exhibition process) to the search location (executing location of search process) is less than the square value of elapsed time (The unit: hour “H”), which is from the entry registration (registration time) to the search (search execution time)”. It turns out that the distance from the entry registration location (executing location of exhibition process) to the search location (executing location of search process) is 30 kilometers, based on the latitude and longitude at search time acquired in Step S1221 and the latitude and longitude at registration time of the entry acquired in Step S1223. In addition, it turns out that elapsed time from the entry registration (registration time) to the search (search execution time) is 44 hours, based on the difference, which is subtraction of the registration time of said entry acquired in Step S1223 from the current time acquired in Step S1222. Therefore, because “30<1936 (=44×44)” is true, namely, “the distance (The unit: kilometer “km”) from the entry registration location (executing location of exhibition process) to the search location (executing location of search process) is less than the square value of elapsed time (The unit: hour “H”) from the entry registration (registration time) to the search (search execution time)”, it proceeds in Step S1226.

The processing section 12 makes the browser 41 through the WEB server 11 display exhibition ID “0001”, item name “ski”, and item description “for child, the color is pink” of the entry selected in Step S1226 of the search process 122. After that, it returns in Step S1224.

As the process of Step S1224 of the search process 122, the processing section 12 selects the entry (two entries) acquired in Step S1223 orderly one by one. This time, it selects the entry which corresponds to exhibition ID “0002”.

As the process of Step S1225 of the search process 122, the processing section 12 evaluates the entry (exhibition ID “0002”) which was selected in Step S1224 “whether or not a distance (The unit: kilometer “km”) from the entry registration location (executing location of exhibition process) to the search location (executing location of search process) is less than the square value of elapsed time (The unit: hour “H”), which is from the entry registration (registration time) to the search (search execution time)”. It turns out that the distance from the entry registration location (executing location of exhibition process) to the search location (executing location of search process) is 1030 kilometers, based on the latitude and longitude at search time acquired in Step S1221 and the latitude and longitude at registration time of entry acquired in Step S1223. In addition, it turns out that elapsed time from the entry registration (registration time) to the search (search execution time) is 42 hours, based on the difference, which is subtraction of the registration time of said entry acquired in Step S1223 from the current time acquired in Step S1222. Therefore, because “1030<1764 (=42×42)” is true, namely, “the distance (The unit: kilometer “km”) from the entry registration location (executing location of exhibition process) to the search location (executing location of search process) is less than the square value of elapsed time (The unit: hour “H”) from the entry registration (registration time) to the search (search execution time)”, it proceeds in Step S1226.

The processing section 12 makes the browser 41 through the WEB server 11 display exhibition ID “0002”, item name “guitar” and item description “out of order, usable if it is repaired” of the entry selected in Step S1226 of the search process 122. After that, it returns in Step S1224.

As the process of Step S1224 of the search process 122, the processing section 12 selects the entry (two entries) acquired in Step S1223 orderly one by one. Here, because it finished choosing all entry (two), it ends processing.

The browser 41 displays the search result sent from the WEB server 11. Then, a series of search operation completes when the searcher confirms the search result screen shown in FIG. 5.

### (Third Example of Operation: Operation of the Order Process)

Hereinafter, referring to FIG. 1-FIG. 2, FIG. 5-FIG. 7 and FIG. 10 and using the example case which a ski is exhibited by using the first item exhibition terminal 2 which is located in Tokyo (“North latitude 35.681111”, “East longitude 139.766667”) at 17:00 on Jul. 15, 2011, a guitar is exhibited by using the second item exhibition terminal 3 which is located in Hakata (“North latitude 33.590292”, “East longitude 130.420611”) at 19:00 on Jul. 15, 2011, the search is done without specifying an item name (leaving the column blank) by using the first item search terminal 4 located in Yokohama (“North latitude 35.506806”, “East longitude 139.616944”) at 13:00 on Jul. 17, 2011, and the searcher make an order, by using the first item search terminal 4, for the item “ski” with exhibition ID “0001” displayed as the search result, operation of the order process will be explained. Here, it is supposed that an order has not done neither for the ski nor the guitar by the time of executing the order process.

A searcher, who wants an item or a product, accesses the WEB server 11 by using the browser 41 in the first item search terminal 4 shown in FIG. 1, executes the search explained in the second example of operation, and acquires the search result screen 412 shown in FIG. 5.

Here, it is supposed that the searcher pushes the order execution button 4124 which corresponds to exhibition ID “0001” shown in FIG. 5.

After the order execution button 4124 is pushed, exhibition ID “0001” and item name “ski”, which correspond to the order execution button, are transferred to the WEB server 11 by using the POST method of HTTP. Then the WEB server 11 returns the order execution screen 413 shown in FIG. 6 to the browser 41.

Here, it is supposed that the searcher inputs “211-8666” in the field of postal code 4133, “1753, Shimonumabe, Yokohama-city” in the field of address 4134, “Hanako Uketori” in the field of name 4135, “044-433-1111” in the field of telephone number 4136, and “123@biglobe.co.jp” in the field of e-mail address 4137 as shown in FIG. 6, and that he pushes the order establishment button 4138 after inputting.

After the order establishment button 4138 is pushed, the contents inputted or set in the order execution screen 413 are transferred to the WEB server 11 by using the POST method of HTTP. Then, the WEB server 11 starts up the order process 123 shown in FIG. 10.

As the process of Step S1231 of the order process 123, the processing section 12 receives from WEB server 11 the information set/displayed in the fields of exhibition ID 4131, postal code 4133, address 4134, name 4135, telephone number 4136, and e-mail address 4137 in the order execution screen 413.

As the process of Step S1232 of the order process 123, the processing section 12 executes a search on the exhibit item DB 13 with a key, which is exhibition ID “0001” acquired in Step S1231, and acquires one entry which corresponds to the exhibition ID. This entry includes exhibition ID “0001”, item name “ski”, item description “for child, the color is pink”, registration time “20110715170000”, latitude of registration location “+35.681111”, longitude of registration location “+139.766667”, and registrant contact “abc@biglobe.co.jp”.

As the process of Step S1233, the processing section 12 makes display the registrant contact acquired in Step S1232 in the field of address 2311. It also makes display a text which represents “order notification”, and exhibition ID and item name acquired in Step S1232 in the field of title 2312. It also makes display a text which indicates that there was an order for the exhibited item or product and that shipment processing should be executed, the exhibition ID and the item name acquired in Step S1232, and postal code, address, name, telephone number and e-mail address, as shipping destination, acquired in Step S1231 in the field of body text. As a result, the e-mail with the contents which is shown in FIG. 7 is generated and is sent to the mailer 23 through the mail server 14.

The exhibitor, who received the order notification by e-mail etc. with the contents shown in FIG. 7 through the mailer 23, sends the exhibited item specified by the order notification shown in FIG. 7 to the address shown in FIG. 7 by home-delivery service etc.

After finishing e-mail transmission process in Step S1233, the processing section 12 executes a search on the exhibit item DB 13 with a key, which is exhibition ID “0001” acquired in Step S1231, and deletes one entry which corresponds to the exhibition ID as the process of Step S1234. With this process, it prevents that more than one order is done to the item or product (ski) which corresponds to the exhibition ID “0001”.

As the process of Step S1235, the processing section 12 makes the browser 41 display through WEB server 11 an indication which indicates that the order process 123 was completed, exhibition ID “0001” acquired in Step S1231 and item name (ski) acquired in Step S1232. Then, said section 12 ends processing.

The browser 41 displays the order process result sent from the WEB server 11. Then, a series of order operation completes when the searcher confirms the order process result (exhibition ID “0001”, item name “ski”).

### (Relationship of Time)

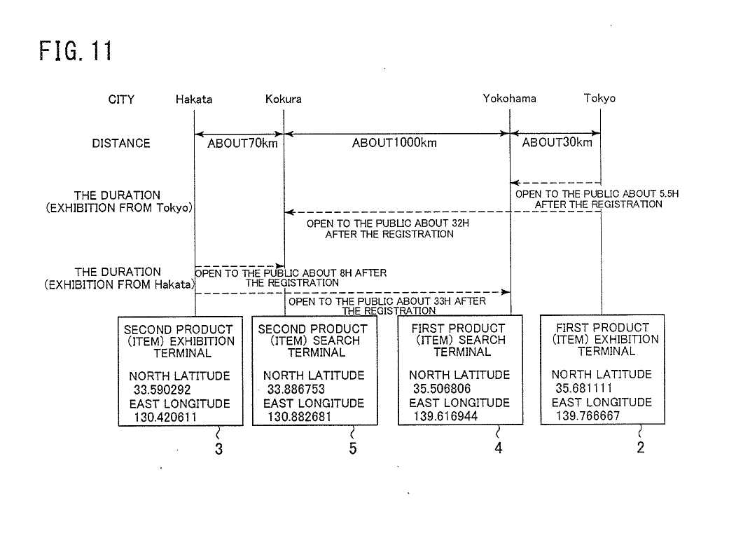

Referring to FIG. 11, relationship of locations among terminals and relationship of time from item registration time to the time when an item search becomes possible will be described below.

In this example of operation, as shown in FIG. 11, it is supposed that the first item exhibition terminal 2 is located in Tokyo (“North latitude 35.681111”, “East longitude 139.766667”), the second item exhibition terminal 3 is located in Hakata (“North latitude 33.590292”, “East longitude 130.420611”), the first item search terminal 4 is located in Yokohama (“North latitude 35.506806”, “East longitude 139.616944”) and the second item search terminal 5 is located in Kokura (“North latitude 33.886753”, “East longitude 130.882681”).

Further, for convenience of description, it is assumed that the cities of Tokyo, Yokohama, Kokura and Hakata are located on a straight line, the distance from the first item exhibition terminal 2 (Tokyo) to the first item search terminal 4 (Yokohama) is 30 km, the distance from the first item search terminal 4 (Yokohama) to the second item search terminal 5 (Kokura) is 1000 km, and the distance from the second item search terminal 5 (Kokura) to the second item exhibition terminal 3 (Hakata) is 70 km.

Applying the distances among terminals shown in FIG. 11 to the condition indicated in Step S1225 shown in FIG. 9, it turns out that the item exhibited from the first item exhibition terminal 2 (Tokyo) becomes searchable from the first item search terminal 4 (Yokohama) which is 30 km apart from said terminal 2 route 30 (0.5 square of 30) hours later, namely about 5.48 hours later. It also turns out that said item becomes searchable from the second item search terminal 5 (Kokura) which is 1030 km apart from said first item exhibition terminal 2 (Tokyo) route 1030 (0.5 square of 1030) hours later, namely about 32 hours later.

Similarly, the item exhibited from the second item exhibition terminal 3 (Hakata) becomes searchable from the second item search terminal 5 (Kokura) which is 70 km apart from said terminal 3 route 70 (0.5 square of 70) hours later, namely about 8.4 hours later. Then, said item becomes searchable from the first item search terminal 4 (Yokohama) which is 1070 km apart from said second item exhibition terminal 3 (Hakata) route 1070 (0.5 square of 1070) hours later, namely about 33 hours later.

### (Relationship Among Exhibition Registration Time, Exhibited Items, Item Exhibition Terminals, Search Execution Time, and Search Results)

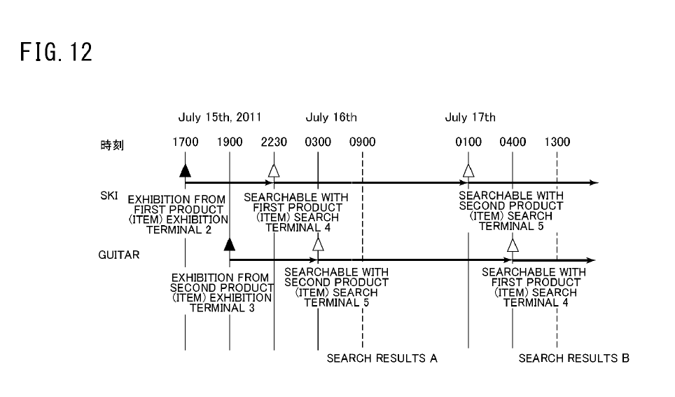

Referring to FIG. 12, relationship among exhibition registration time, exhibited items, item exhibition terminals, search execution time, and search results will be described below.

It is supposed that the first item exhibition terminal 2, the first item search terminal 4 and the second item search terminal 5 exists on the locations shown in FIG. 11, and that a ski is exhibited from the first item exhibition terminal 2 at 17:00:00, Jul. 15, 2011 as shown in FIG. 12. As for the first item search terminal 4 which is 30 km apart from the first item exhibition terminal 2, the ski becomes searchable after about 22:30, Jul. 15, 2011. Then, as for the second item search terminal 5 which is 1030 km apart from the first item exhibition terminal 2, the ski becomes searchable after about 01:00, Jul. 17, 2011.

It is supposed that the second item exhibition terminal 3, the first item search terminal 4 and the second item search terminal 5 exists on the locations shown in FIG. 11, and that a guitar is exhibited from the second item exhibition terminal 3 at 19:00:00, Jul. 15, 2011 as shown in FIG. 12. As for the second item search terminal 5 which is 70 km apart from the second item exhibition terminal 3, the guitar becomes searchable after about 03:00, Jul. 16, 2011. Then, as for the first item search terminal 4 which is 1070 km apart from the second item exhibition terminal 3, the guitar becomes searchable after about 04:00, Jul. 17, 2011.

### (Example of Search Results)

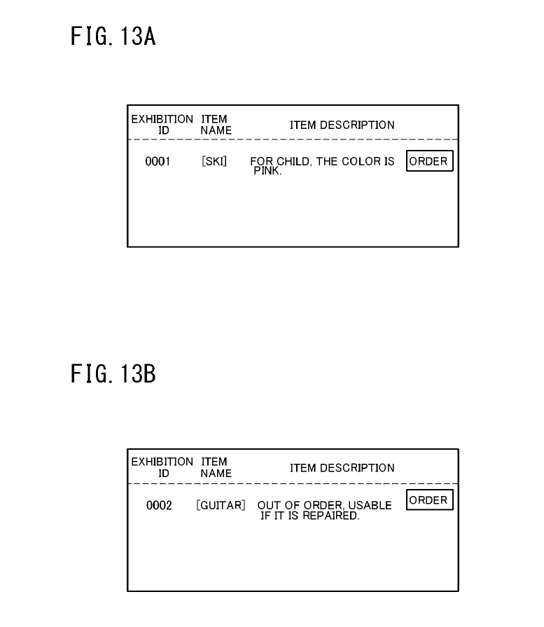

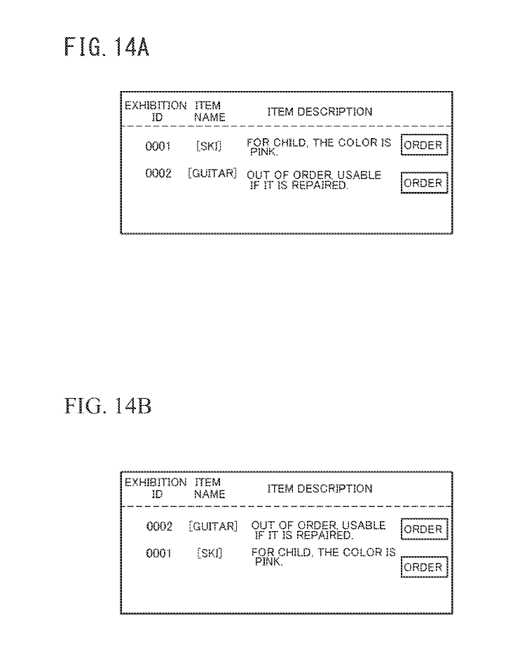

Referring to FIG. 13A, FIG. 13B, FIG. 14A and FIG. 14B and using the case that terminals exist on the locations shown in FIG. 11, items or products shown in FIG. 12 are exhibited at the dates and time shown in FIG. 12 and searches are executed without identifying item names (leave the column blank) at specified search time by using the first item search terminal 4 and the second item search terminal 5, the search results will be described below.

### (Search Results A)

Referring to FIG. 13A and FIG. 13B, the search results (search results A), in case that searches are executed without identifying item name (leave the column blank) at “09:00, Jul. 16, 2011” by using the first item search terminal 4 and the second item search terminal 5, will be described below.

Here, it is supposed that there was no order from the time of item exhibition process completion to the time of displaying the search results (search results A).

According to FIG. 13 A, as for the first item search terminal 4, only a ski is displayed as the search result.

According to FIG. 13 B, as for the second item search terminal 5, only a guitar is displayed as the search result.

### (Search Results B)

Referring to FIG. 14A and FIG. 14B, the search results (search results B), in case that searches are executed without identifying item names (leave the column blank) at “13:00, Jul. 17, 2011” by using the first item search terminal 4 and the second item search terminal 5, will be described below.

Here, it is supposed that there was no order from the time of item exhibition process completion to the time of displaying the search results (search results B).

According to FIG. 14 A and FIG. 14B, as for both the first item search terminal 4 and the second item search terminal 5, both a ski and a guitar are displayed as the search results.

### Effect of the First Exemplary Embodiment

Next, effect of the present exemplary embodiment will be described below.

In the practice of the present exemplary embodiment, transportation time, a transportation cost or an amount of carbon dioxide emission can be reduced in the case of offering (transferring or selling etc.) “limited item” (limited number item, limited sales period item, limited shop item, regionally limited item, and other rare item etc.).

The reason is as follows:

Only when the distance (The unit: kilometer “km”) from the entry registration location (executing location of exhibition process 121) to the search location (executing location of search process) is less than the square value of elapsed time (The unit: hour “H”), which is from the entry registration (registration time) to the search (search execution time), exhibited item of said entry is displayed. Therefore, the searcher with the closer distance from the exhibitor acquires the right to order more early.

### Second Exemplary Embodiment

The second exemplary embodiment of the present invention will be described below.

The second exemplary embodiment of the present invention differs from the first exemplary embodiment of the present invention at the point that operation executed by the processing section 12 (exhibition process 121, search process 122, and order process 123) of the first exemplary embodiment of the present invention is executed by browser 21, browser 31, browser 41 or browser 51, and therefore a processing load of an item search server 1 can be distributed.

### (System Configuration)

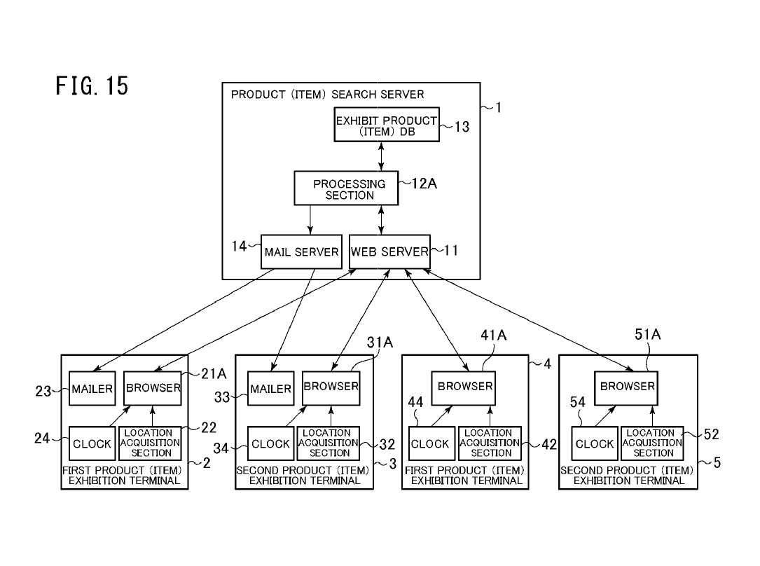

Referring to FIG. 15, configuration of an item search system according to the second exemplary embodiment of the present invention will be described below.

An item search server 1 differs from the item search server 1 of the first exemplary embodiment of the present invention at the points that said server 1 has a processing section 12A instead of the processing section 12 and said server 1 does not have a clock 15.

The processing section 12A receives a request from the WEB server 11, registers information on the exhibit item DB 13 or read information from the exhibit item DB 13 if necessary, and returns a result to the WEB server 11. Furthermore, the processing section 12A sends e-mail through the mail server 14 if necessary. In addition, the processing section 12A has a register to manage the exhibition IDs.

The first item exhibition terminal 2 differs from the first item exhibition terminal 2 of the first exemplary embodiment of the present invention at the points that said terminal 2 has a browser 21A instead of the browser 21 and said terminal 2 has a clock 24.

The browser 21A executes the exhibition process 121 in addition to the same operation of the browser 21 of the first exemplary embodiment of the present invention. However, because the browser 21A does not have a register for managing exhibition IDs, number adoption of exhibition ID in Step S1212 is performed by inquiring the register of the processing section 12A. Further, the time in Step S1213 is acquired from the clock 24. Then, DB registration in Step S1214 is performed by accessing the exhibit item DB 13 through the WEB server 11 and the processing section 12A.

The clock 24 returns the current date and time (year, month, day, hour, minute, and second) in response to a request from the browser 21A. The clock 24 always retains the exact date and time by using NTP (Network Time Protocol), GPS (Global Positioning System) or the like.

The second item exhibition terminal 3 has the same configuration with the first item exhibition terminal 2 of the present exemplary embodiment and executes the same operation with said terminal 2.

The first item search terminal 4 differs from the first item search terminal 4 of the first exemplary embodiment of the present invention at the points that said terminal 4 has a browser 41A instead of the browser 41 and said terminal 4 has a clock 44.

The browser 41A executes the search process 122 and the order process 123 in addition to the same operation of the browser 41 of the first exemplary embodiment of the present invention. The time in Step S1222 is acquired from the clock 44. DB search in Step S1223 and S1232 and entry elimination in Step S1234 are performed by accessing the exhibit item DB 13 through the WEB server 11 and the processing section 12A. Further, the transmission of order notification in Step S1233 is executed by the mail server 14 through the WEB server 11 and the processing section 12A.

The clock 44 has the same configuration with the clock 24 of the present exemplary embodiment and executes the same operation with said clock 24.

The second item search terminal 5 has the same configuration with the first item search terminal 4 of the present exemplary embodiment and executes the same operation with said terminal 4.

### (Example of Operation)

In the present exemplary embodiment, the exhibition process 121, the search process 122 and the order process 123 of the first exemplary embodiment is executed by one of browser 21, browser 31, browser 41 and browser 51 instead of the processing section 12. Except for this point, the operation is the same as the first exemplary embodiment.

### Effect of the Second Exemplary Embodiment

Next, effect of the present exemplary embodiment will be described below.

By the practice of the present exemplary embodiment, transportation time, a transportation cost or an amount of carbon dioxide emission can be minimized in the case of offering (transferring or selling etc.) limited item.

The reason is as follows:

Only when the distance (The unit: kilometer “km”) from the entry registration location (executing location of exhibition process 121) to the search location (executing location of search process) is less than the square value of elapsed time (The unit: hour “H”), which is from the entry registration (registration time) to the search (search execution time), exhibited item of said entry is displayed. Therefore, the searcher with the closer distance from the exhibitor acquires the right to order more early.

Further, by the practice of the present exemplary embodiment, a processing load of the item search server is reduced and therefore services can be offered to a lot of exhibitors and searchers.

The reason is that the processing load can be distributed because each terminal executes the processing which is possible to implement in each of the item exhibition terminals and the item search terminals.

### Third Exemplary Embodiment

The third exemplary embodiment of the present invention will be described below.

The third exemplary embodiment of the present invention differs from the first exemplary embodiment of the present invention at the points that in determining whether or not to display exhibit item of the entry, judgment is made under the consideration of a transportation cost (The unit: Japanese Yen “Yen”) from the entry registration location (executing location of exhibition process) to the search location (executing location of search process) instead of the distance (The unit: kilometer “km”) from the entry registration location (executing location of exhibition process) to the search location (executing location of search process).

### (System Configuration)

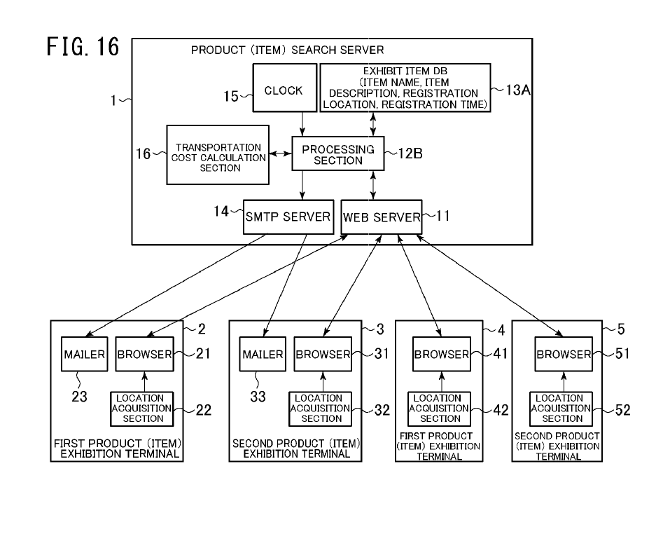

Referring to FIG. 16, a configuration of an item search system according to the third exemplary embodiment of the present invention will be described below.

An item search server 1 differs from the item search server 1 of the first exemplary embodiment of the present invention at the points that said server 1 has a processing section 12B and an exhibit item DB 13A instead of the processing section 12 and the exhibit item DB 13, and that said server has a transportation cost calculation section 16.

The processing section 12B differs from the processing section 12 of the first exemplary embodiment of the present invention at the points that said section 12B executes a search process 122A instead of the search process 122 in search processing, and that said section 12B refers to the exhibit item DB 13A instead of the exhibit item DB 13.

The exhibit item DB 13A differs from the exhibit item DB 13 of the first exemplary embodiment of the present invention at the point that said exhibit item DB 13A stores size 138 and weight 139 additionally.

The transportation cost calculation section 16 receives notification about size, weight, exhibitor's latitude, exhibitor's longitude, searcher's latitude, and searcher's longitude from the processing section 12B. Then, said section 16 identifies exhibitor's address and searcher's address from their longitude and latitude. Further, said section 16 calculates a transportation cost from an exhibitor to a searcher by referring to a transportation cost table contained in said section 16, and returns the result to the processing section 12B.

### (Configuration of the Exhibit Item DB)

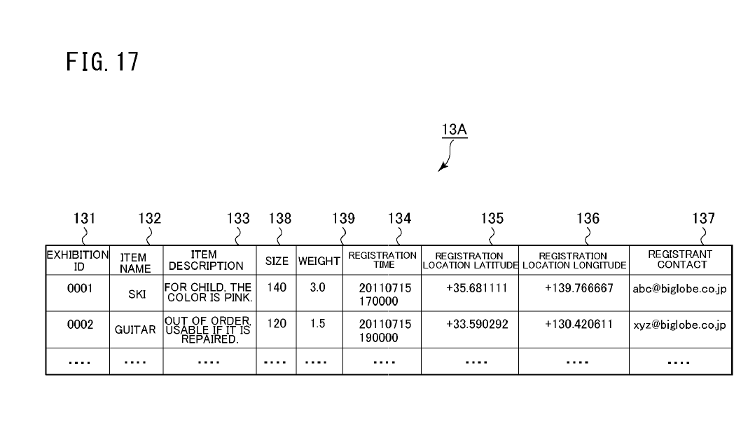

Referring to FIG. 17, a configuration example of the exhibit item DB 13A will be described below.

The exhibit item DB 13A differs from the exhibit item DB 13 of the first exemplary embodiment of the present invention at the point that said exhibit item DB 13A stores size 138 and weight 139 additionally.

Size 138 is a field for recording total size of three sides, which are the length, the width, and the height of an exhibited item or product (The unit: centimeter “cm”).

Weight 139 is a field for recording weight of an exhibited item or product (The unit: kilogram “kg”).

### (Configuration of an Item Registration Screen)

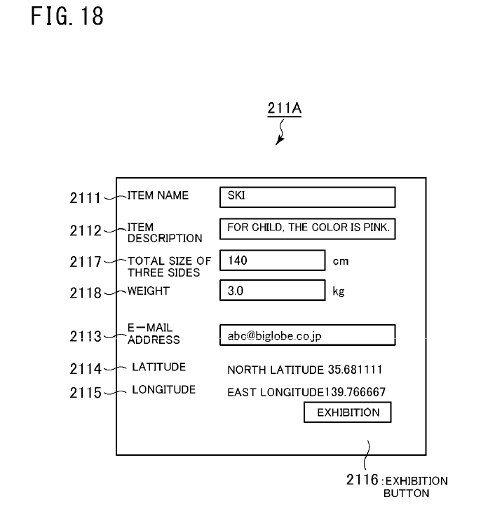

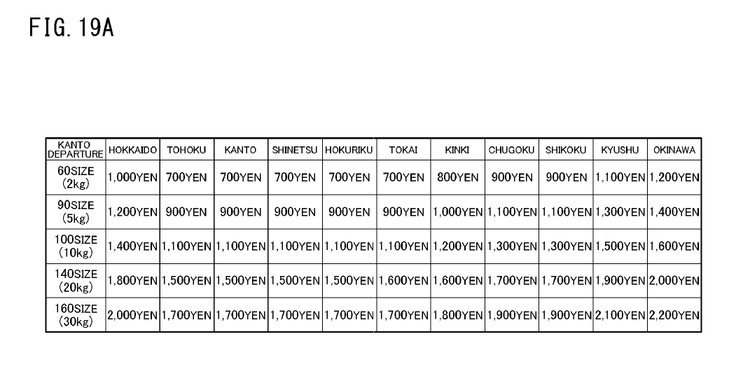

Referring to FIG. 18, a configuration example of an item registration screen 211A displayed in the browser 21 when an exhibitor executes the exhibition process 121 for an item or product will be described below.

The item registration screen 211A differs from the item registration screen 211 of the first exemplary embodiment of the present invention at the point that an item of total size of three sides 2117 and an item of weight 2118 are added to.

Total size of three sides 2117 is a field for setting total size of three sides, which are the length, the width, and the height of an exhibited item or product (the unit: centimeter “cm”). For example, as for “the length 100 cm”, “the width 20 cm”, and “the height 20 cm”, “100+20+20=140” is set to.

Weight 2118 is a field for recording a weight after the packing of an exhibited item or product (the unit: kilogram “kg”). For example, if the weight after the packing is “3000 g”, “3.0” is set to.

### (A Transportation Cost Table)

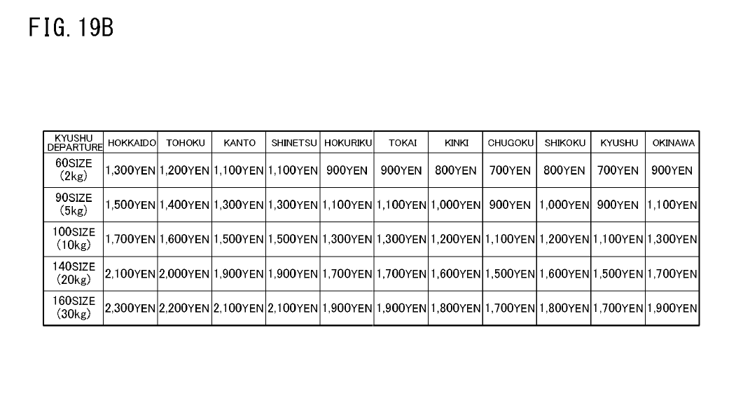

Referring to FIG. 19 A and FIG. 19B, examples of transportation cost tables “Kanto departure” and “Kyushu departure” will be described below.

The transportation cost calculation section 16 receives notification about size, weight, exhibitor's latitude, exhibitor's longitude, searcher's latitude, and searcher's longitude from the processing section 12B. Then, said section 16 identifies exhibitor's address and searcher's address from their longitude and latitude. Further, said section 16 calculates a transportation cost from the exhibitor to the searcher by referring to a transportation cost table contained in said section 16, and returns the result to the processing section 12B. At this time, the transportation cost table is selected in accordance with the address of an exhibitor. For example, if it turned out that the address of the exhibitor is in Tokyo based on exhibitor's longitude and latitude, a transportation cost is calculated by using the transportation cost table “Kanto departure”.

Further, the transportation cost calculation section 16 refers to a size and a weight notified from the processing section 12B in calculating the transportation cost, and selects the transportation cost, whichever is higher. For example, if total size of three sides is “50 cm” and the weight is “3 kg”, the transportation cost of the “size 80” instead of “size 60” is applied. Conversely, if the weight is “3 kg” and total size of three sides is “90 cm”, the transportation cost of “100 size” instead of “size 80” is applied.

### (Operation of a Search Process)

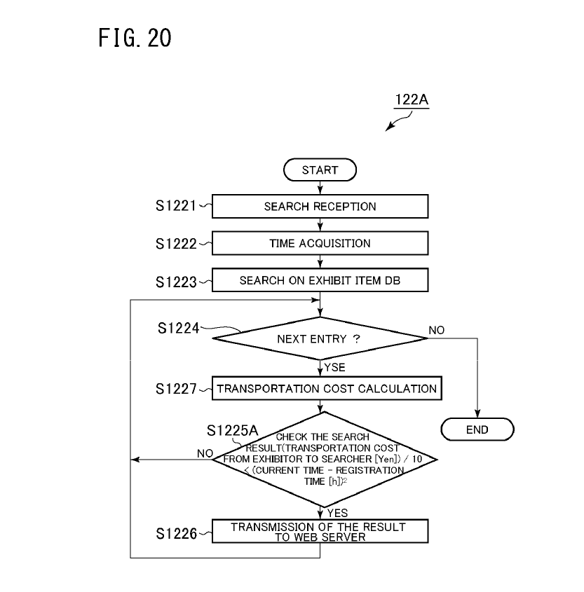

Referring to FIG. 20, operation of a search process 122A executed in the processing section 12B will be described below.

The search process 122A differs from the search process 122 of the first exemplary embodiment of the present invention at the points that: Step S1227, which is step to calculate a transportation cost, is added to between Step S1224 and Step S1225; the judgment is made under the consideration of the transportation cost (The unit: Japanese Yen “Yen”) from the entry registration location (executing location of exhibition process) to the search location (executing location of search process) instead of the distance (The unit: kilometer “km”) from the entry registration location (executing location of exhibition process) to the search location (executing location of search process) in checking search results in Step S1225; and this step is called 1225A instead of step 1225.

### (1) Step S1221

The processing section 12B starts up the search process 122A when said processing section receives from the WEB server 11 the information which is set/displayed in the fields of item name 4111, latitude 4112, and longitude 4113 in the search execution screen 411 by the searcher.

### (2) Step S1222

The processing section 12B acquires the current date and time (year, month, day, hour, minute, and second) from the clock 15.

### (3) Step S1223

The processing section 12B executes a search on the exhibit item DB 13A with keys, which are the latitude and longitude acquired in Step S1221, and acquires a maximum of 200 entries in the order in which the distance from the spot with the latitude and longitude is closer. Here, if an item name was specified, namely a field of item name was not being left as a blank column in step S1221, search results are narrowed by using the item name. Each entry acquired as a result of executing the search on the exhibit item DB 13A includes exhibition ID, item name, item description, registration time, latitude of registration location, longitude of registration location, and registrant contact.

### (4) Step S1224

The processing section 12B selects the entry (maximum of 200 entries) acquired in Step S1223 orderly one by one. If an entry which should be selected exists, it proceeds in Step S1227. If an entry which should be selected does not exist, it ends processing.

### (5) Step S1227

Regarding to an entry selected in Step S1224, the processing section 12B notifies size, weight, exhibitor's latitude, exhibitor's longitude, searcher's latitude, and searcher's longitude to the transportation cost calculation section 16, and receives the transportation cost from the exhibitor to the searcher as a result. Here, the transportation cost from the entry registration location (executing location of exhibition process) to the search location (executing location of search process) is calculated based on the latitude and longitude at search time acquired in Step S1221, the latitude and longitude at registration time of the entry, size, and weight acquired in Step S1223.

### (6) Step S1225A

The processing section 12B evaluates the entry which was selected in Step S1224 “whether or not 1/10 of the transportation cost (The unit: Japanese Yen “Yen”) from the entry registration location (executing location of exhibition process) to the search location (executing location of search process) is less than the square value of elapsed time (The unit: hour “H”), which is from the entry registration (registration time) to the search (search execution time)”. If the evaluation is “YES”, it proceeds in Step S1226. If the evaluation is “NO”, it returns in Step S1224 and selects next entry. Further, elapsed time (The unit: hour “H”) from the entry registration (registration time) to the search (search execution time) is calculated by using the difference, which is subtraction of the registration time of the entry acquired in Step S1223 from the current time acquired in Step S1222.

### (7) Step S1226

If the evaluation for the entry selected in Step S1225 is “YES”, the processing section 12B sends exhibition ID, item name, and item description of the entry to the WEB server 11. Then, said section 12B makes display the contents of entry in the search result screen 412. After that, it returns in Step S1224 and selects next entry.

### (First Example of Operation: Operation of the Exhibition Process)

Operation of the exhibition process is same as the first example of operation of the first exemplary embodiment of the present invention except the points that a total size of three sides and a weight are additionally notified in pushing down the exhibition button 2116 in the item registration screen 211A, and the total size of three sides and the weight are additionally stored on the exhibit item DB 13A at the time of DB registration (Step S1214) of the exhibition process 121.

### (Second Example of Operation: Operation of the Search Process)

Hereinafter, referring to FIG. 16, FIG. 17, FIG. 4, FIG. 5, FIG. 19A, FIG. 19B and FIG. 20 and using the example case which a ski, whose total size of three sides is “140 cm” and whose weight is “3 kg”, is exhibited by using the first item exhibition terminal 2 which is located in Tokyo (“North latitude 35.681111”, “East longitude 139.766667”) at 17:00 on Jul. 15, 2011, a guitar, whose total size of three sides is “120 cm” and whose weight is “1.5 kg”, is exhibited by using the second item exhibition terminal 3 which is located in Hakata (“North latitude 33.590292”, “East longitude 130.420611”) at 19:00 on Jul. 15, 2011, and the search is done without specifying an item name (leaving the column blank) by using the first item search terminal 4 located in Yokohama (“North latitude 35.506806”, “East longitude 139.616944”) at 13:00 on Jul. 17, 2011, operation of the search process will be explained. Here, it is supposed that an order has been done neither for the ski nor the guitar by the time of the display of the search result.

A searcher, who wants an item or a product, accesses the WEB server 11 by using the browser 41 in the first item search terminal 4 shown in FIG. 1, and acquires the search execution screen 411 shown in FIG. 16.

In displaying the search execution screen 411, the browser 41 acquires the latitude and longitude of the first item search terminal 4 from the location acquisition section 42 and displays latitude 4112 and longitude 4113 in the search execution screen 411. Here, it is supposed that latitude 4112 is “North latitude 35.506806” and longitude 4113 is “East longitude 139.616944”.

Here, it is supposed that the searcher pushes a search execution button 4114 with leaving the field of item name 4111 blank, as indicated in FIG. 4.

After the search execution button 4114 is pushed, the contents inputted or set in the search execution screen 411 are transferred to the WEB server 11 by using the POST method of HTTP. Then, the WEB server 11 starts up the search process 122A shown in FIG. 20.

As the process of Step S1221 of the search process 122A, the processing section 12B receives from WEB server 11 the information set/displayed in the field of item name 4111, latitude 4112 and longitude 4113 in the search execution screen 411.

As the process of Step S1222 of the search process 122A, the processing section 12B acquires the current date and time (year, month, day, hour, minute, and second) from the clock 15. As a result, the processing section 12B acquires a value, “20110717130000”.

As the process of Step S1223 of the search process 122A, the processing section 12B executes a search on the exhibit item DB 13A with keys, which are the latitude and longitude (“North latitude 35.506806”, “East longitude 139.616944”) acquired in Step S1221, and acquires a maximum of 200 entries in the order in which the distance from the spot with the latitude and longitude is closer. Here, it is supposed that two entries whose exhibition IDs are “0001” and “0002” shown in FIG. 17 could be acquired. This time, because the field of the item name is a blank column, narrowing the search results by using the item name are not executed.

As the process of Step S1224 of the search process 122A, the processing section 12B selects the entry (two entries) acquired in Step S1223 orderly one by one. At first, it selects the entry which corresponds to exhibition ID “0001”.

As the process of Step S1227 of the search process 122A, regarding to the entry selected (exhibition ID “0001”) in Step S1224, the processing section 12B calculates a transportation cost from the entry registration location (executing location of exhibition process) to the search location (executing location of search process). Here, it turns out that the searcher is located in Kanagawa based on the latitude and longitude at the time of search, the exhibitor is located in Tokyo based on the latitude and longitude at the time of the entry registration acquired in Step S1223, size is “140 cm” and weight is “3 kg”. Therefore, referring to “Kanto departure”, “Kanto destination” and “140 size” in FIG. 19A, a transportation cost “1500 Yen” is calculated.

As the process of Step S1225A of the search process 122A, the processing section 12B evaluates the entry (exhibition ID “0001”) which was selected in Step S1224 “whether or not 1/10 of the transportation cost (The unit: Japanese Yen “Yen”) from the entry registration location (executing location of exhibition process) to the search location (executing location of search process) is less than the square value of elapsed time (The unit: hour “H”), which is from the entry registration (registration time) to the search (search execution time)”. Here, it turns out that the transportation cost from the entry registration location (executing location of exhibition process) to the search location (executing location of search process) is “1500 Yen” based on the result of Step S1227. In addition, it turns out that elapsed time from the entry registration (registration time) to the search (search execution time) is 44 hours, based on the difference, which is subtraction of the registration time of said entry acquired in Step S1223 from the current time acquired in Step S1222. Therefore, because 150 (1500/10)<1936 (=44×44) is true, namely, “ 1/10 of the transportation cost (The unit: Japanese Yen “Yen”) from the entry registration location (executing location of exhibition process) to the search location (executing location of search process) is less than the square value of elapsed time (The unit: hour “H”) from the entry registration (registration time) to the search (search execution time)”, it proceeds in Step S1226.

The processing section 12B makes the browser 41 through the WEB server 11 display exhibition ID “0001”, item name “ski”, and item description “for child, the color is pink” of the entry selected in Step S1226 of the search process 122A. After that, it returns in Step S1224.

As the process of Step S1224 of the search process 122A, the processing section 12B selects the entry (two entries) acquired in Step S1223 orderly one by one. This time, it selects the entry which corresponds to exhibition ID “0002”.

As the process of Step S1227 of the search process 122A, regarding to the entry selected (exhibition ID “0002”) in Step S1224, the processing section 12B calculates a transportation cost from the entry registration location (executing location of exhibition process) to the search location (executing location of search process). Here, it turns out that the searcher is located in Kanagawa based on the latitude and longitude at the time of search, the exhibitor is located in Hukuoka prefecture based on the latitude and longitude at the time of the entry registration acquired in Step S1223, size is “120 cm” and weight is “1.5 kg”. Therefore, referring to “Kyushu departure”, “Kanto destination” and “140 size” in FIG. 19B, the transportation cost “1900 Yen” is calculated.

As the process of Step S1225A of the search process 122A, the processing section 12B evaluates the entry (exhibition ID “0002”) which was selected in Step S1224 “whether or not 1/10 of the transportation cost (The unit: Japanese Yen “Yen”) from the entry registration location (executing location of exhibition process) to the search location (executing location of search process) is less than the square value of elapsed time (The unit: hour “H”) from the entry registration (registration time) to the search (search execution time)”. Here, it turns out that the transportation cost from the entry registration location (executing location of exhibition process) to the search location (executing location of search process) is “1900 Yen” based on the result of Step S1227. In addition, it turns out that elapsed time from the entry registration (registration time) to the search (search execution time) is 42 hours, based on the difference, which is subtraction of the registration time of said entry acquired in Step S1223 from the current time acquired in Step S1222. Therefore, because 190 (1900/10)<1764 (=42×42) is true, namely, “ 1/10 of the transportation cost (The unit: Japanese Yen “Yen”) from the entry registration location (executing location of exhibition process) to the search location (executing location of search process) is less than the square value of elapsed time (The unit: hour “H”) from the entry registration (registration time) to the search (search execution time)”, it proceeds in Step S1226.

The processing section 12B makes the browser 41 through the WEB server 11 display exhibition ID “0002”, item name “guitar”, and item description “out of order, usable if it is repaired” of the entry selected in Step S1226 of the search process 122A. After that, it returns in Step S1224.

As the process of Step S1224 of the search process 122A, the processing section 12B selects the entry (two entries) acquired in Step S1223 orderly one by one. Here, because it finished choosing all entry (two), it ends processing.

The browser 41 displays the search result sent from the WEB server 11. Then, a series of search operation completes when the searcher confirms the search result screen shown in FIG. 5.

### (Third Example of Operation: Operation of an Order Process)

Operation of an order process of the present exemplary embodiment is same as third example of operation of first exemplary embodiment of the present invention.

### Effect of the Third Exemplary Embodiment

Next, effect of the present exemplary embodiment will be described below.

By the practice of the present exemplary embodiment, a transportation cost can be minimized in the case of offering (transferring or selling etc.) limited item.

The reason is as follows:

Only when 1/10 of the transportation cost (The unit: Japanese Yen “Yen”) from the entry registration location (executing location of exhibition process 121) to the search location (executing location of search process) is less than the square value of elapsed time (The unit: hour “H”) from the entry registration (registration time) to the search (search execution time), exhibited item of said entry is displayed. Therefore, the searcher with the cheaper transportation cost acquires the right to order more early.

### Fourth Exemplary Embodiment

The fourth exemplary embodiment of the present invention will be described below.

The fourth exemplary embodiment of the present invention differs from the third exemplary embodiment of the present invention at the points that in determining whether or not to display exhibit item of the entry, judgment is made under the consideration of a transportation cost (The unit: Japanese Yen “Yen”)/weight “kg” from the entry registration location (executing location of exhibition process) to the search location (executing location of search process) instead of the transportation cost (The unit: Japanese Yen “Yen”) from the entry registration location (executing location of exhibition process) to the search location (executing location of search process).

The transportation cost increases in proportion to the distance and the size or the weight. So, by dividing by the weight, excluding the influence of the size and the weight, transportation time or an amount of carbon dioxide emission can be minimized.

### (System Configuration)

A configuration of an item search system of the fourth exemplary embodiment is similar with that of the third exemplary embodiment of the present invention.

The configuration of the item search system of the present exemplary embodiment differs from that of the third exemplary embodiment at the point that the processing section 12B executes search process 122B instead of search process 122A in search processing.

### (Operation of a Search Process)

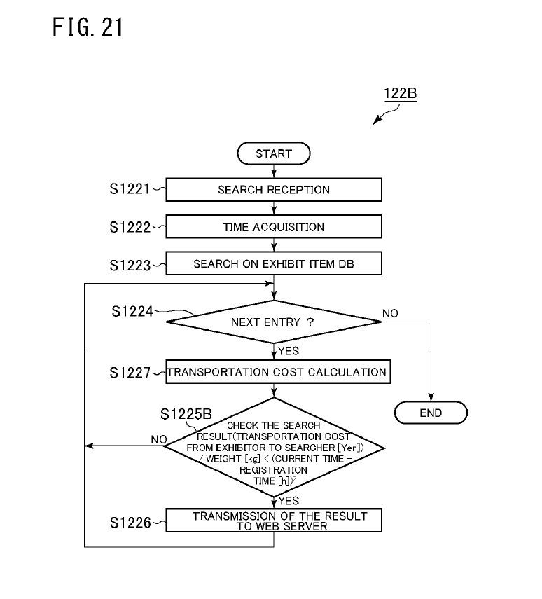

Referring to FIG. 21, operation of a search process 122B executed in the processing section 12B will be described below.

The search process 122B differs from the search process 122A of the third exemplary embodiment of the present invention at the points that judgment is made under the consideration of a transportation cost (The unit: Japanese Yen “Yen”)/weight (The unit: kilogram “kg”) from the entry registration location (executing location of exhibition process) to the search location (executing location of search process) instead of the transportation cost (The unit: Japanese Yen “Yen”) from the entry registration location (executing location of exhibition process) in checking the search result in Step S1225A, and this step is called 1225B instead of step 1225A.

### (1) Step S1221

The processing section 12B starts up the search process 122B when said processing section receives from the WEB server 11 the information which is set/displayed in the fields of item name 4111, latitude 4112 and longitude 4113 in the search execution screen 411 by the searcher.

### (2) Step S1222

The processing section 12B acquires the current date and time (year, month, day, hour, minute, and second) from the clock 15.

### (3) Step S1223

The processing section 12B executes a search on the exhibit item DB 13A with keys, which are the latitude and longitude acquired in Step S1221, and acquires a maximum of 200 entries in the order in which the distance from the spot with the latitude and longitude is closer. Here, if an item name was specified, namely a field of item name was not being left as a blank column in step S1221, search results are narrowed by using the item name. Each entry acquired as a result of executing the search on the exhibit item DB 13A includes exhibition ID, item name, item description, registration time, latitude of registration location, longitude of registration location, and registrant contact.

### (4) Step S1224

The processing section 12B selects the entry (maximum of 200 entries) acquired in Step S1223 orderly one by one. If an entry which should be selected exists, it proceeds in Step S1227. If an entry which should be selected does not exist, it ends processing.

### (5) Step S1227

Regarding to the entry selected in Step S1224, the processing section 12B notifies size, weight, exhibitor's latitude, exhibitor's longitude, searcher's latitude, and searcher's longitude to the transportation cost calculation section 16, and receives the transportation cost from the exhibitor to the searcher as a result. Here, the transportation cost from the entry registration location (executing location of exhibition process) to the search location (executing location of search process) is calculated based on the latitude and longitude at search time acquired in Step S1221 and the latitude and longitude at registration time of the entry, size, and weight acquired in Step S1223.

### (6) Step S1225B

The processing section 12B evaluates the entry which was selected in Step S1224 “whether or not a transportation cost (The unit: Japanese Yen “Yen”) from the entry registration location (executing location of exhibition process) to the search location (executing location of search process) divided by weight (The unit: kilogram “kg”) is less than the square value of elapsed time (The unit: hour “H”), which is from the entry registration (registration time) to the search (search execution time)”. If the evaluation is “YES”, it proceeds in Step S1226. If the evaluation is “NO”, it returns in Step S1224 and selects next entry. Further, elapsed time (The unit: hour “H”) from the entry registration (registration time) to the search (search execution time) is calculated by using the difference, which is subtraction of the registration time of the entry acquired in Step S1223 from the current time acquired in Step S1222.

### (7) Step S1226

If the evaluation for the entry selected in Step S1225 is “YES”, the processing section 12B sends exhibition ID, item name, and item description of the entry to the WEB server 11. Then said section 12B makes display the contents of entry in the search result screen 412. After that, it returns in Step S1224 and selects next entry.

### (First Example of Operation: Operation of an Exhibition Process)

The exhibition process of the present exemplary embodiment is same as that of the first example of operation of the third exemplary embodiment.

### (Second Example of Operation: Operation of the Search Process)

Hereinafter, referring to FIG. 16, FIG. 17, FIG. 4, FIG. 5, FIG. 19A, FIG. 19B, and FIG. 21 and using the example case which a ski, whose total size of three sides is “140 cm” and whose weight is “3 kg”, is exhibited by using the first item exhibition terminal 2 which is located in Tokyo (“North latitude 35.681111”, “East longitude 139.766667”) at 17:00 on Jul. 15, 2011, a guitar, whose total size of three sides is “120 cm” and whose weight is “1.5 kg”, is exhibited by using the second item exhibition terminal 3 which is located in Hakata (“North latitude 33.590292”, “East longitude 130.420611”) at 19:00 on Jul. 15, 2011, and the search is done without specifying an item name (leaving the column blank) by using the first item search terminal 4 located in Yokohama (“North latitude 35.506806”, “East longitude 139.616944”) at 13:00 on Jul. 17, 2011, operation of the search process will be explained. Here, it is supposed that an order has been done neither for the ski nor the guitar by the time of the display of the search result.

A searcher, who wants an item or a product, accesses the WEB server 11 by using the browser 41 in the first item search terminal 4 shown in FIG. 16, and acquires the search execution screen 411 shown in FIG. 4.

In displaying the search execution screen 411, the browser 41 acquires the latitude and longitude of the first item search terminal 4 from the location acquisition section 42 and displays latitude 4112 and longitude 4113 in the search execution screen 411. Here, it is supposed that latitude 4112 is “North latitude 35.506806” and longitude 4113 is “East longitude 139.616944”.

Here, it is supposed that the searcher pushes a search execution button 4114 with leaving the field of item name 4111 blank, as indicated in FIG. 4.

After the search execution button 4114 is pushed, the contents inputted or set in the search execution screen 411 are transferred to the WEB server 11 by using the POST method of HTTP. Then, the WEB server 11 starts up the search process 122B shown in FIG. 21.

As the process of Step S1221 of the search process 122B, the processing section 12B receives from WEB server 11 the information set/displayed in the field of item name 4111, latitude 4112, and longitude 4113 in the search execution screen 411.

As the process of Step S1222 of the search process 122B, the processing section 12B acquires the current date and time (year, month, day, hour, minute, and second) from the clock 15. As a result, the processing section 12B acquires a value, “20110717130000”.

As the process of Step S1223 of the search process 122B, the processing section 12B executes a search on the exhibit item DB 13A with keys, which are the latitude and longitude (“North latitude 35.506806”, “East longitude 139.616944”) acquired in Step S1221, and acquires a maximum of 200 entries in the order in which the distance from the spot with the latitude and longitude is closer. Here, it is supposed that two entries whose exhibition IDs are “0001” and “0002” shown in FIG. 17 could be acquired. This time, because the field of the item name is a blank column, narrowing the search results by using the item name are not executed.

As the process of Step S1224 of the search process 122B, the processing section 12B selects the entry (two entries) acquired in Step S1223 orderly one by one. At first, it selects the entry which corresponds to exhibition ID “0001”.

As the process of Step S1227 of the search process 122B, regarding to the entry selected (exhibition ID “0001”) in Step S1224, the processing section 12B calculates a transportation cost from the entry registration location (executing location of exhibition process) to the search location (executing location of search process). Here, it turns out that the searcher is located in Kanagawa based on the latitude and longitude at the time of search, the exhibitor is located in Tokyo based on the latitude and longitude at the time of the entry registration acquired in Step S1223, size is “140 cm” and weight is “3 kg”. Therefore, referring to “Kanto departure”, “Kanto destination” and “140 size” in FIG. 19A, a transportation cost “1500 Yen” is calculated.

As the process of Step S1225B of the search process 122B, the processing section 12B evaluates the entry (exhibition ID “0001”) which was selected in Step S1224, “whether or not a transportation cost (The unit: Japanese Yen “Yen”) from the entry registration location (executing location of exhibition process) to the search location (executing location of search process) divided by weight (result of division) is less than the square value of elapsed time, which is (The unit: hour “H”) from the entry registration (registration time) to the search (search execution time)”. Here, it turns out that the transportation cost from the entry registration location (executing location of exhibition process) to the search location (executing location of search process) is “1500 Yen” based on the result of Step S1227. In addition, it turns out that elapsed time from the entry registration (registration time) to the search (search execution time) is 44 hours, based on the difference which is subtraction of the registration time of said entry acquired in Step S1223 from the current time acquired in Step S1222. Therefore, because “500 (1500/3)<1936 (=44×44)” is true, namely, “the transportation cost (The unit: Japanese Yen “Yen”) from the entry registration location (executing location of exhibition process) to the search location (executing location of search process) divided by the weight (The unit: kilogram “kg”) (result of division) is less than the square value of elapsed time (The unit: hour “H”) from the entry registration (registration time) to the search (search execution time)”, it proceeds in Step S1226.

The processing section 12B makes the browser 41 through the WEB server 11 display exhibition ID “0001”, item name “ski”, and item description “for child, the color is pink” of the entry selected in Step S1226 of the search process 122B. After that, it returns in Step S1224.

As the process of Step S1224 of the search process 122B, the processing section 12B selects the entry (two entries) acquired in Step S1223 orderly one by one. This time, it selects the entry which corresponds to exhibition ID “0002”.

As the process of Step S1227 of the search process 122B, regarding to the entry selected (exhibition ID “0002”) in Step S1224, the processing section 12B calculates a transportation cost from the entry registration location (executing location of exhibition process) to the search location (executing location of search process). Here, it turns out that the searcher is located in Kanagawa based on the latitude and longitude at the time of search, the exhibitor is located in Hukuoka prefecture based on the latitude and longitude at the time of the entry registration acquired in Step S1223, size is “120 cm” and weight is “1.5 kg”. Therefore, referring to “Kyushu departure”, “Kanto destination” and “140 size” in FIG. 19B, a transportation cost “1900 Yen” are calculated.

As the process of Step S1225B of the search process 122B, the processing section 12B evaluates the entry (exhibition ID “0002”) which was selected in Step S1224, “whether or not a transportation cost (The unit: Japanese Yen “Yen”) from the entry registration location (executing location of exhibition process) to the search location (executing location of search process) divided by weight (result of division) is less than the square value of elapsed time (The unit: hour “H”), which is from the entry registration (registration time) to the search (search execution time)”. Here, it turns out that the transportation cost from the entry registration location (executing location of exhibition process) to the search location (executing location of search process) is “1900 Yen” based on the result of Step S1227. In addition, it turns out that elapsed time from the entry registration (registration time) to the search (search execution time) is 42 hours, based on the difference, which is subtraction of the registration time of said entry acquired in Step S1223 from the current time acquired in Step S1222. Therefore, because 1266 (1900/1.5)<1764 (=42×42)” is true, namely, “the transportation cost (The unit: Japanese Yen “Yen”) from the entry registration location (executing location of exhibition process) to the search location (executing location of search process) divided by the weight (The unit: kilogram “kg”) (result of division) is less than the square value of elapsed time (The unit: hour “H”) from the entry registration (registration time) to the search (search execution time)”, it proceeds in Step S1226.

The processing section 12B makes the browser 41 through the WEB server 11 display exhibition ID “0002”, item name “guitar”, and item description “out of order, usable if it is repaired” of the entry selected in Step S1226 of the search process 122B. After that, it returns in Step S1224.

As the process of Step S1224 of the search process 122B, the processing section 12B selects the entry (two entries) acquired in Step S1223 orderly one by one. Here, because it finished choosing all entry (two), it ends processing.

The browser 41 displays the search result sent from the WEB server 11. Then, a series of search operation completes when the searcher confirms the search result screen shown in FIG. 5.

### (Third Example of Operation: Operation of an Order Process)

Operation of an order process of the present exemplary embodiment is same as that of third example of operation of third exemplary embodiment of the present invention.

### Effect of the Fourth Exemplary Embodiment

Next, effect of the present exemplary embodiment will be described below.

By the practice of the present exemplary embodiment, transportation time or an amount of carbon dioxide emission can be minimized in the case of offering (transferring or selling etc.) limited item.

The reason is as follows:

Only when a transportation cost (The unit: Japanese Yen “Yen”) from the entry registration location (executing location of exhibition process 121) to the search location (executing location of search process) divided by the weight (The unit: kilogram “kg”) (result of division) is less than the square value of elapsed time (The unit: hour “H”) from the entry registration (registration time) to the search (search execution time), the exhibit item of said entry is displayed. Therefore, the searcher with smaller transportation cost divided by weight acquires the right to order more early.

### Fifth Exemplary Embodiment

The fifth exemplary embodiment of the present invention will be described below.

The fifth exemplary embodiment of the present invention differs from third exemplary embodiment of the present invention at the points that in determining whether or not to display exhibited item of the entry, judgment is made under the consideration of a transportation cost (The unit: Japanese Yen “Yen”)/(size “cm”/10) from the entry registration location (executing location of exhibition process) to the search location (executing location of search process) instead of the transportation cost (The unit: Japanese Yen “Yen”) from the entry registration location (executing location of exhibition process) to the search location (executing location of search process).

The transportation cost increase in proportion to the distance and the size or the weight. So, by dividing by the size, excluding the influence of the size and weight, transportation time or an amount of carbon dioxide emission can be minimized.

### (System Configuration)

The configuration of an item search system of the fifth exemplary embodiment is similar with that of the third exemplary embodiment of the present invention.

The configuration of the item search system of the present exemplary embodiment differs from that of the third exemplary embodiment at the point that the processing section 12B executes search process 122C instead of search process 122A in search processing.

### (Operation of a Search Process)

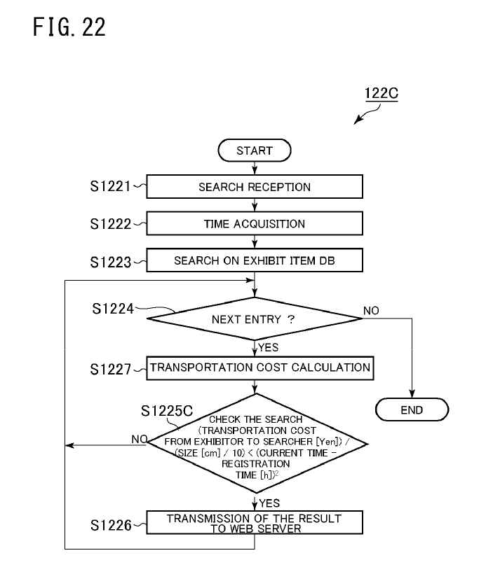

Referring to FIG. 22, operation of search process 122C executed in the processing section 12B will be described below.

The search process 122C differs from the search process 122A of the third exemplary embodiment of the present invention at the points that the judgment is made under the consideration of a transportation cost (The unit: Japanese Yen “Yen”)/tenth of size (The unit: centimeter “cm”) from the entry registration location (executing location of exhibition process) to the search location (executing location of search process) instead of the transportation cost (The unit: Japanese Yen “Yen”) from the entry registration location (executing location of exhibition process) in checking the search result in Step S1225A, and this step is called 1225C instead of step 1225A.

### (1) Step S1221

The processing section 12B starts up search process 122C when said processing section receives from the WEB server 11 the information which is set/displayed in the fields of item name 4111, latitude 4112, and longitude 4113 in the search execution screen 411 by the searcher.

### (2) Step S1222

The processing section 12B acquires the current date and time (year, month, day, hour, minute, and second) from the clock 15.

### (3) Step S1223

The processing section 12B executes a search on the exhibit item DB 13A with keys, which are the latitude and longitude acquired in Step S1221, and acquires a maximum of 200 entries in the order in which the distance from the spot with the latitude and longitude is closer. Here, if an item name was specified, namely a field of item name was not being left as a blank column in step S1221, search results are narrowed by using the item name. Each entry acquired as a result of executing the search on the exhibit item DB 13A includes exhibition ID, item name, item description, registration time, latitude of registration location, longitude of registration location, and registrant contact.

### (4) Step S1224

The processing section 12B selects the entry (maximum of 200 entries) acquired in Step S1223 orderly one by one. If an entry which should be selected exists, it proceeds in Step S1227. If an entry which should be selected does not exist, it ends processing.

### (5) Step S1227

Regarding to the entry selected in Step S1224, the processing section 12B notifies size, weight, exhibitor's latitude, exhibitor's longitude, searcher's latitude, and searcher's longitude to the transportation cost calculation section 16, and receives the transportation cost from the exhibitor to the searcher as a result. Here, the transportation cost from the entry registration location (executing location of exhibition process) to the search location (executing location of search process) is calculated based on the latitude and longitude at search time acquired in Step S1221 and the latitude and longitude at registration time of the entry, size, and weight acquired in Step S1223.

### (6) Step S1225C

The processing section 12B evaluates the entry which was selected in Step S1224 “whether or not a transportation cost (The unit: Japanese Yen “Yen”) from the entry registration location (executing location of exhibition process) to the search location (executing location of search process) divided by tenth of size (The unit: centimeter “cm”) (result of division) is less than the square value of elapsed time (The unit: hour “H”), which is from the entry registration (registration time) to the search (search execution time)”. If the evaluation is “YES”, it proceeds in Step S1226. If the evaluation is “NO”, it returns in Step S1224 and selects next entry. Further, elapsed time (The unit: hour “H”) from the entry registration (registration time) to the search (search execution time) is calculated by using the difference, which is subtraction of the registration time of the entry acquired in Step S1223 from the current time acquired in Step S1222.

### (7) Step S1226

If the evaluation for the entry selected in Step S1225 is “YES”, the processing section 12B sends exhibition ID, item name, and item description of the entry to the WEB server 11. Then said section 12B makes display the contents of entry in the search result screen 412. After that, it returns in Step S1224 and selects next entry.

### (First Example of Operation: Operation of an Exhibition Process)

The exhibition process of the present exemplary embodiment is same as that of the first example of operation of the third exemplary embodiment.

### (Second Example of Operation: Operation of the Search Process)

Hereinafter, referring to FIG. 16, FIG. 17, FIG. 4, FIG. 5, FIG. 19A, FIG. 19B, and FIG. 22 and using the example case which a ski, whose total size of three sides is “140 cm” and whose weight is “3 kg”, is exhibited by using the first item exhibition terminal 2 which is located in Tokyo (“North latitude 35.681111”, “East longitude 139.766667”) at 17:00 on Jul. 15, 2011, a guitar, whose total size of three sides is “120 cm” and whose weight is “1.5 kg”, is exhibited by using the second item exhibition terminal 3 which is located in Hakata (“North latitude 33.590292”, “East longitude 130.420611”) at 19:00 on Jul. 15, 2011, and the search is done without specifying an item name (leaving the column blank) by using the first item search terminal 4 located in Yokohama (“North latitude 35.506806”, “East longitude 139.616944”) at 13:00 on Jul. 17, 2011, operation of the search process will be explained. Here, it is supposed that an order has been done neither for the ski nor the guitar by the time of the display of the search result.

A searcher, who wants an item or a product, accesses the WEB server 11 by using the browser 41 in the first item search terminal 4 shown in FIG. 16, and acquires the search execution screen 411 shown in FIG. 4.

In displaying the search execution screen 411, the browser 41 acquires the latitude and longitude of the first item search terminal 4 from the location acquisition section 42 and displays latitude 4112 and longitude 4113 in the search execution screen 411. Here, it is supposed that latitude 4112 is “North latitude 35.506806” and longitude 4113 is “East longitude 139.616944”.

Here, it is supposed that the searcher pushes a search execution button 4114 with leaving the field of item name 4111 blank, as indicated in FIG. 4.

After the search execution button 4114 is pushed, the contents inputted or set in the search execution screen 411 are transferred to the WEB server 11 by using the POST method of HTTP. Then, the WEB server 11 starts up the search process 122C shown in FIG. 22.

As the process of Step S1221 of the search process 122C, the processing section 12B receives information, from WEB server 11, set/displayed in the field of item name 4111, latitude 4112 and longitude 4113 in the search execution screen 411.

As the process of Step S1222 of the search process 122C, the processing section 12B acquires the current date and time (year, month, day, hour, minute, and second) from the clock 15. As a result, the processing section 12 acquires a value, “20110717130000”.

As the process of Step S1223 of the search process 122C, the processing section 12B executes a search on the exhibit item DB 13A with keys, which are the latitude and longitude (“North latitude 35.506806”, “East longitude 139.616944”) acquired in Step S1221, and acquires a maximum of 200 entries in the order in which the distance from the spot with the latitude and longitude is closer. Here, it is supposed that two entries whose exhibition IDs are “0001” and “0002” shown in FIG. 17 could be acquired. This time, because the field of the item name is a blank column, narrowing the search results by using the item name are not executed.

As the process of Step S1224 of the search process 122C, the processing section 12B selects the entry (two entries) acquired in Step S1223 orderly one by one. At first, it selects the entry which corresponds to exhibition ID “0001”.

As the process of Step S1227 of the search process 122C, regarding to the entry selected (exhibition ID “0001”) in Step S1224, the processing section 12B calculates a transportation cost from the entry registration location (executing location of exhibition process) to the search location (executing location of search process). Here, it turns out that the searcher is located in Kanagawa based on the latitude and longitude at the time of search, the exhibitor is located in Tokyo based on the latitude and longitude at the time of the entry registration acquired in Step S1223, size is “140 cm” and weight is “3 kg”. Therefore, referring to “Kanto departure”, “Kanto destination” and “140 size” in FIG. 19A, a transportation cost “1500 Yen” is calculated.

As the process of Step S1225C of the search process 122C, the processing section 12B evaluates the entry (exhibition ID “0001”) which was selected in Step S1224, “whether or not a transportation cost (The unit: Japanese Yen “Yen”) from the entry registration location (executing location of exhibition process) to the search location (executing location of search process) divided by tenth of size (result of division) is less than the square value of elapsed time (The unit: hour “H”), which is from the entry registration (registration time) to the search (search execution time)”. Here, it turns out that the transportation cost from the entry registration location (executing location of exhibition process) to the search location (executing location of search process) is “1500 Yen” based on the result of Step S1227. In addition, it turns out that elapsed time from the entry registration (registration time) to the search (search execution time) is 44 hours, based on the difference which is the subtraction of registration time of said entry acquired in Step S1223 from the current time acquired in Step S1222. Therefore, because “107 (1500/14)<1936 (=44×44)” is true, namely, “the transportation cost (The unit: Japanese Yen “Yen”) from the entry registration location (executing location of exhibition process) to the search location (executing location of search process) divided by tenth of the size (result of division) is less than the square value of elapsed time (The unit: hour “H”) from the entry registration (registration time) to the search (search execution time)”, it proceeds in Step S1226.

The processing section 12B makes the browser 41 through the WEB server 11 display exhibition ID “0001”, item name “ski”, and item description “for child, the color is pink” of the entry selected in Step S1226 of the search process 122C. After that, it returns in Step S1224.

As the process of Step S1224 of the search process 122C, the processing section 12B selects the entry (two entries) acquired in Step S1223 orderly one by one. This time, it selects the entry which corresponds to exhibition ID “0002”.

As the process of Step S1227 of the search process 122C, regarding to the entry selected (exhibition ID “0002”) in Step S1224, the processing section 12B calculates a transportation cost from the entry registration location (executing location of exhibition process) to the search location (executing location of search process). Here, it turns out that the searcher is located in Kanagawa based on the latitude and longitude at the time of search, the exhibitor is located in Hukuoka prefecture based on the latitude and longitude at the time of the entry registration acquired in Step S1223, size is “120 cm” and weight is “1.5 kg”. Therefore, referring to “Kyushu departure”, “Kanto destination” and “140 size” in FIG. 19B, a transportation cost “1900 Yen” is calculated.

As the process of Step S1225C of the search process 122C, the processing section 12B evaluates the entry (exhibition ID “0002”) which was selected in Step S1224, “whether or not a transportation cost (The unit: Japanese Yen “Yen”) from the entry registration location (executing location of exhibition process) to the search location (executing location of search process) divided by tenth of size (result of division) is less than the square value of elapsed time (The unit: hour “H”), which is from the entry registration (registration time) to the search (search execution time)”. Here, it turns out that the transportation cost from the entry registration location (executing location of exhibition process) to the search location (executing location of search process) is “1900 Yen” based on the result of Step S1227. In addition, it turns out that elapsed time from the entry registration (registration time) to the search (search execution time) is 42 hours, based on the difference which is the subtraction of the registration time of said entry acquired in Step S1223 from the current time acquired in Step S1222. Therefore, because “158 (1900/12)<1764 (=42×42)” is true, namely, “the transportation cost (The unit: Japanese Yen “Yen”) from the entry registration location (executing location of exhibition process) to the search location (executing location of search process) divided by tenth of the size (The unit: centimeter “cm”) (result of division) is less than the square value of elapsed time (The unit: hour “H”) from the entry registration (registration time) to the search (search execution time)”, it proceeds in Step S1226.

The processing section 12B makes the browser 41 through the WEB server 11 display exhibition ID “0002”, item name “guitar”, and item description “out of order, usable if it is repaired” of the entry selected in Step S1226 of the search process 122C. After that, it returns in Step S1224.

As the process of Step S1224 of the search process 122C, the processing section 12B selects the entry (two entries) acquired in Step S1223 orderly one by one. Here, because it finished choosing all entry (two), it ends processing.

The browser 41 displays the search result sent from the WEB server 11. Then, a series of search operation completes when the searcher confirms the search result screen shown in FIG. 5.

### (Third Example of Operation: Operation of an Order Process)

Operation of an order process of the present exemplary embodiment is same as that of third example of operation of third exemplary embodiment of the present invention.

### Effect of the Fifth Exemplary Embodiment

Next, effect of the present exemplary embodiment will be described below.

By the practice of the present exemplary embodiment, transportation time or an amount of carbon dioxide emission can be minimized in the case of offering (transferring or selling etc.) limited item.

The reason is as follows:

Only when a transportation cost (The unit: Japanese Yen “Yen”) from the entry registration location (executing location of exhibition process 121) to the search location (executing location of search process) divided by tenth of the total size of three sides (The unit: centimeter “cm”) (result of division) is less than the square value of elapsed time (The unit: hour “H”) from the entry registration (registration time) to the search (search execution time), the exhibit item of said entry is displayed. Therefore, the searcher with smaller transportation cost divided by tenth of size acquires the right to order more early.

### (Remarks)

So far, in the exemplary embodiment, as an example, the case of two item exhibition terminals and two item search terminals was explained, but the case of more than three item exhibition terminals and more than three item search terminals is practicable similarly.

In the above description, it is possible to combine the item exhibition terminal and the item search terminal to execute all of the item exhibition, the search, and the order by one terminal.

In addition, in the exemplary embodiment, as an example, the case that only-first-person can order was explained, but the case that more than two persons with an amount limitation, for example 100-first-persons, can order is practicable similarly.

In the above description, although the present invention is explained referring to the exemplary embodiments, the present invention is not limited to the above exemplary embodiments. It is practicable with various modifications understandable for those skilled in the art. Of course, it is possible to implement the present invention by combining above mentioned exemplary embodiments each other.

### INDUSTRIAL APPLICABILITY

This invention can be applied to the item sales (EC: electric commerce) service, auction service, item transfer service, and so on, which is offered by the internet service business entity, the freight operator, and so on.

### FEATURES OF THE PRESENT INVENTION

As described above, the present invention relates to a display method for search results in item transfer or sales service using the network. Particularly in the case of offering (transferring, selling, etc.) limited items, the present invention relates to a product search system, a product search server, a product search terminal, a product search method, and program for reducing transportation time, a transportation cost, or an amount of carbon dioxide emission by making the searcher with the closer distance from the exhibitor enable to acquire the right to order the limited items.

The product search server of this invention includes: a WEB server which communicates with a product exhibition terminal and a product search terminal; processing section which performs processing in response to requests such as exhibition requests, search requests, order requests; a clock which holds and returns the current time; exhibit item DB which stores information of exhibited item, registration time, latitude and longitude of a registration location, and registrant contact; and a mail server which sends order notification.

The purpose of this invention can be achieved by adopting above mentioned configuration and making the searcher with closer distance from the exhibitor enable to acquire the right to order more early: because only when the distance (The unit: kilometer “km”) from the entry registration location (exhibition process instruction place) to the search location (search process instruction place) is less than the square value of elapsed time (The unit: hour “H”) from the entry registration (registration time) to the search (search execution time), exhibited item of said entry is displayed.

The product search system of this invention includes: a WEB server by which the product search server communicates with a product exhibition terminal and a product search terminal; a processing section which performs processing in response to requests such as exhibition requests, search requests, order requests; a clock which holds and returns the current time; an exhibit item DB which stores information of exhibited item, registration time, latitude and longitude of a registration location, and registrant contact; and a mail server which sends order notification. Then, the product exhibition terminal displays screen sent from the WEB server. Further, said product search system includes: a browser for transferring to the WEB server inputted contents by the exhibitor and latitude and longitude of a terminal location as a request; a location acquisition section for measuring the latitude and longitude of the terminal location by technique such as GPS; and a mailer for receiving and displaying e-mail from the mail server. Then, the product search terminal displays screen sent from the WEB server. In addition, said product search system includes: a browser for transferring to the WEB server inputted contents by the searcher and latitude and longitude of a terminal location as a request; and a location acquisition section for measuring the latitude and longitude of the terminal location by technique such as GPS.

The purpose of this invention can be achieved by adopting above mentioned configuration and making the searcher with closer distance from the exhibitor enable to acquire the right to order more early: because only when the distance (The unit: kilometer “km”) from the entry registration location (exhibition process instruction place) to the search location (search process instruction place) is less than the square value of elapsed time (The unit: hour “H”) from the entry registration (registration time) to the search (search execution time), exhibited item of said entry is displayed.

### (1) First Effect

By the present invention, in the case of offering (transferring or selling etc.) limited item, transportation time, a transportation cost or an amount of carbon dioxide emission can be reduced.

The reason is as follows:

Only when the distance (The unit: kilometer “km”) from the entry registration location (exhibition process instruction place) to the search location (search process instruction place) is less than the square value of elapsed time (The unit: hour “H”) from the entry registration (registration time) to the search (search execution time), the exhibit item of said entry is displayed. Therefore, the searcher with the closer distance from the exhibitor acquires the right to order more early.

Alternatively, the reason is as follows: Only when 1/10 of the transportation cost (The unit: Japanese Yen “Yen”) from the entry registration location (exhibition process instruction place) to the search location (search process instruction place) is less than the square value of elapsed time (The unit: hour “H”) from the entry registration (registration time) to the search (search execution time), the exhibit item of said entry is displayed. Therefore, the searcher with the cheaper transportation cost acquires the right to order more early.

Alternatively, the reason is as follows: Only when the transportation cost (The unit: Japanese Yen “Yen”) from the entry registration location (exhibition process instruction place) to the search location (search process instruction place) divided by the weight (The unit: kilogram “kg”) (result of division) is less than the square value of elapsed time (The unit: hour “H”) from the entry registration (registration time) to the search (search execution time), the exhibit item of said entry is displayed. Therefore, the searcher with the smaller transportation cost divided by weight acquires the right to order more early.

Alternatively, the reason is as follows: Only when the transportation cost (The unit: Japanese Yen “Yen”) from the entry registration location (exhibition process instruction place) to the search location (search process instruction place) divided by tenth of the total size of three sides (The unit: centimeter “cm”) (result of division) is less than the square value of elapsed time (The unit: hour “H”) from the entry registration (registration time) to the search (search execution time), the exhibit item of said entry is displayed. Therefore, the searcher with smaller transportation cost divided by tenth of size acquires the right to order more early.

### (2) Second Effect

In the present invention, a processing load of an item search server is reduced and therefore services can be offered to a lot of exhibitors and searchers.

The reason is that the processing load can be distributed because each terminal executes the processing which is possible to implement in each of item exhibition terminals and item search terminals.

### (Supplementary Note)

The part or all of above-mentioned exemplary embodiment can be described as supplementary notes described below. However, in practice, it is not limited to the described examples as follows.

### (Supplementary Note 1)

A product search server for searching a limited product comprising:

a processing section for executing a search process;

a current time holding section for holding current time;

a searcher location receiving section for receiving location information of a searcher; and

an exhibition information storage section for storing product information, registration time, and a registration location of an exhibited item or product, wherein said processing section searches only a product which meets a condition that the current time has exceeded allowable elapsed time from product registration time, wherein said elapsed time is calculated by using a product registration location and a searcher location.

### (Supplementary Note 2)

The product search server according to supplementary note 1, wherein said allowable elapsed time becomes longer as a distance between the product registration location and the searcher location becomes longer.

### (Supplementary Note 3)

The product search server according to supplementary note 1, further comprising a transportation cost calculation section for calculating a transportation cost between the product registration location and the searcher location, wherein said processing section calculates said allowable elapsed time based on the transportation cost which is calculated by using the product registration location and the searcher location.

### (Supplementary Note 4)

A product search terminal for searching a limited product comprising:

a browser for inquiring product information, registration time, and a registration location of an exhibited item or product and executing a search process;

a current time holding section for holding current time; and

a searcher location receiving section for receiving location information of a searcher,

wherein said browser searches only a product which meets a condition that the current time has exceeded allowable elapsed time from product registration time, wherein said elapsed time is calculated by using a product registration location and a searcher location.

### (Supplementary Note 5)

The product search terminal according to supplementary note 4, wherein said allowable elapsed time becomes longer as the distance between the product registration location and the searcher location becomes longer.

### (Supplementary Note 6)

The product search terminal according to supplementary note 4, further comprising: a transportation cost calculation section for calculating a transportation cost between the product registration location and the searcher location, wherein said browser calculates said allowable elapsed time based on the transportation cost which is calculated by using the product registration location and the searcher location.

### (Supplementary Note 7)

A product search system for offering (transferring or selling) a limited product comprising:

a product search server;

a product exhibition terminal; and

a product search terminal,

wherein said product search server comprises:
a processing section for performing a process in response to a request such as an exhibition request, a search requests, an order request, etc.;
a current time holding section for holding current time;
a searcher location receiving section for receiving location information of a searcher; and
an exhibition information storage section for storing product information, registration time, and a registration location of an exhibited item or product,
wherein said exhibition terminal comprises:
a browser for displaying a screen sent from a WEB server and transferring to the WEB server inputted contents by an exhibitor and latitude and longitude of a terminal location as an exhibition request; and
a location acquisition section for measuring the latitude and longitude of the exhibition terminal location,

wherein said search terminal comprises:
a browser for displaying a screen sent from the WEB server and transferring to the WEB server inputted contents by an searcher and latitude and longitude of a terminal location as an search request; and
a location acquisition section for measuring the latitude and longitude of the search terminal location by technique such as GPS, wherein said processing section searches only a product which meets a condition that the current time has exceeded allowable elapsed time from product registration time, wherein said elapsed time is calculated by using a product registration location and the searcher location.

### (Supplementary Note 8)

The product search system according to supplementary note 7, wherein said allowable elapsed time becomes longer as a distance between the product registration location and the searcher location becomes longer.

### (Supplementary Note 9)

The product search system according to supplementary note 7, further comprising a transportation cost calculation section for calculating a transportation cost between the product registration location and the searcher location, wherein said processing section calculates said allowable elapsed time based on the transportation cost which is calculated by using the product registration location and the searcher location.

### (Supplementary Note 10)

A product search method for searching a limited product comprising:

calculating allowable elapsed time by using a product registration location and a searcher location; and

displaying only a product which meets a condition that current time has exceeded the allowable elapsed time from a product registration time.

### (Supplementary Note 11)

A program for searching a limited product comprising:

calculating allowable elapsed time by using a product registration location and a searcher location; and

displaying only a product which meets the condition that current time has exceeded the allowable elapsed time from a product registration time.

In above-mentioned explanation, “product” can be read as “item” Products are, basically, items which are transferred (sold) for a fee.

Although exemplary embodiments of the present invention are described above in detail, it is apparent that the present invention is not limited to the above exemplary embodiments, but may be modified and changed in practice without departing from the scope and spirit of the invention.

This application is based on the Japanese Patent Application No. 2011-208868 filed on Sep. 26, 2011, claiming the right of priority by this application and the disclosure thereof is entirely incorporated herein by reference.

1. A product search system comprising:
a product search server;
a product exhibition terminal; and
a product search terminal,
wherein said product search server comprises:
a WEB server for offering a limited product;
a processing section for performing a process in response to a request to said WEB server;
a current time holding section for holding current time;
a searcher location receiving section for receiving location information of a searcher; and
an exhibition information storage section for storing product information, registration time, and a registration location of an exhibited product,
wherein said exhibition terminal comprises:
a location acquisition section for measuring latitude and longitude of an exhibition terminal location; and
a browser for displaying screen sent from said WEB server and transferring to said WEB server inputted contents by an exhibitor and the latitude and longitude of the exhibition terminal location as an exhibition request,
wherein said product search terminal comprises:
a location acquisition section for measuring latitude and longitude of a search terminal location; and
a browser for displaying screen sent from said WEB server and transferring to said WEB server inputted contents by a searcher and the latitude and longitude of the search terminal location as a search request, and
wherein said processing section calculates allowable elapsed time based on a product registration location and a searcher location, and searches a product which meets a condition that the current time has exceeded said allowable elapsed time from product registration time.

2. The product search system according to claim 1, wherein said processing section changes said allowable elapsed time in accordance with a distance between the product registration location and the searcher location.

3. The product search system according to claim 1, wherein said product search server further comprises:
a transportation cost calculation section for calculating a transportation cost between the product registration location and the searcher location by using the product registration location and the searcher location, and
wherein said processing section calculates said allowable elapsed time based on said transportation cost.

4. The product search system according to claim 3, wherein said transportation cost calculation section calculates a value obtained by dividing the transportation cost by product's weight, and
wherein said processing section sends a search result to said WEB server in a case that the value is less than a square value of elapsed time which is from the product registration time to search time.

5. The product search system according to claim 3, wherein said transportation cost calculation section calculates a value obtained by dividing the transportation cost by product's size, and
wherein said processing section sends a search result to said WEB server in a case that the value is less than a square value of elapsed time which is from the product registration time to search time.

6. A product search server comprising:
a WEB server for offering a limited product;
a processing section for performing a process in response to a request to said WEB server;
a current time holding section for holding current time;
a searcher location receiving section for receiving location information of a searcher; and
an exhibition information storage section for storing product information, registration time, and a registration locations of an exhibited product,
wherein said processing section calculates allowable elapsed time based on a product registration location and a searcher location, and searches a product which meets a condition that the current time has exceeded said allowable elapsed time from product registration time.

7. A product search terminal for searching a limited product comprising:
a browser for inquiring product information, registration time, and a registration location of an exhibited product and executing a search process;
a current time holding section for holding current time; and
a location acquisition section for acquiring a searcher location,
wherein said browser displays a product which meets a condition that the current time has exceeded allowable elapsed time from product registration time, wherein said elapsed time is calculated by using a product registration location and the searcher location.

8. A product search method comprising:
offering a limited product by using a WEB server;
performing a process in response to a request to said WEB server;
holding current time;
acquiring location information of a searcher;
storing product information, registration time, and a registration location of an exhibited product;
calculating allowable elapsed time based on a product registration location and a searcher location; and
searching a product which meets a condition that the current time has exceeded said elapsed time from product registration time.

9. A non-transitory computer-readable recording medium on which records a computer-executable program to make a computer perform following steps:
offering a limited product by using a WEB server;
performing a process in response to a request to said WEB server;
holding current time;
acquiring location information of a searcher;
storing product information, registration time, and a registration location of an exhibited product;
calculating allowable elapsed time based on a product registration location and a searcher location; and
searching a product which meets a condition that the current time has exceeded said elapsed time from product registration time.
